(19) United States
(12) Patent Application Publication
(10) Pub. No.: US 2025/0341467 A1
(43) Pub. Date: Nov. 6, 2025

(54) PIXELATING WITH CONCENTRATION-ENCODED PHOTOELECTRONS FOR MOLECULAR IMAGING

(71) Applicant: The Board of Trustees of the University of Illinois, Urbana, IL (US)

(72) Inventors: Haohua Tu, Savoy, IL (US); Geng Wang, Urbana, IL (US)

(21) Appl. No.: 19/036,550

(22) Filed: Jan. 24, 2025

Related U.S. Application Data
(60) Provisional application No. 63/625,974, filed on Jan. 27, 2024.

(51) Int. Cl. G01N 21/64; G06T 5/10; G06T 7/80

(52) U.S. Cl. CPC G01N 21/6456; G01N 21/6428; G06T 5/10; G06T 7/80; G01N 2021/6439; G01N 2201/127; G06T 2207/20048

(57) ABSTRACT

Quantitative molecular imaging using an analog photodetector includes receiving, with a processor, output signal data from an analog photodetector. The output signal data are converted to photon count data by receiving calibration data with the processor, converting the output signal data to photoelectron count data using the calibration data, and converting the photoelectron count data to photon count data using a probability of converting photons into photoelectrons. The calibration data relate gray values in the output signal data to a number of detected photoelectrons for the analog photodetector.

### CROSS-REFERENCE TO RELATED APPLICATIONS

This application claims priority to and the benefit of U.S. Provisional Application No. 63/625,974, filed Jan. 27, 2024, the entire contents of which are herein incorporated by reference for all purposes.

### STATEMENT OF FEDERALLY SPONSORED RESEARCH

N/A.

### BACKGROUND

With the development of high peak-power laser sources, label-free autofluorescence multi-harmonic nonlinear microscopy has also evolved from a low-signal-rate signal output of far less than one photon per pulse to a high-signal-rate of up to multiple photons per pulse. As a result, photon-counting photodetection is also replaced by analog photodetection that can detect multiple photons simultaneously, just like labeled nonlinear microscopy that may obtain multiple photons per pulse due to the use of bright fluorescent dyes. Unlike a photon counting PMT that can directly output the number of photons, an analog PMT outputs current/voltage, which is also affected by the PMT gain, amplifying/attenuating devices, and digitizer settings. Therefore, for systems using an analog PMT, it is critical to convert the analog output into photon counts in order to achieve quantitative imaging ability.

Label-free nonlinear optical microscopy (multiphoton/multi-harmonic) has become a powerful tool for biomedical research due to its advantages of low invasiveness, deep penetration, lack of out-of-focus bleaching, high resolution, etc., especially in neuroscience, oncology, and immunology. With the development of high peak-power laser sources, label-free autofluorescence multi-harmonic nonlinear microscopy has also evolved from low-signal-rate imaging with far less than one photon per pulse to high-signal-rate imaging with up to multiple photons per pulse. As a result, photon-counting photodetection by a photomultiplier (PMT) is also replaced by analog photodetection using a PMT that can detect multiple photons simultaneously, just like the labeled nonlinear microscopy that may obtain multiple photons per pulse due to the use of bright fluorescent agents. Unlike the photon counting PMT that can directly output the number of photons, the analog PMT outputs current/voltage, which is also affected by the PMT gain, amplifying/attenuating devices, and digitizer settings. Therefore, for systems using an analog PMT, it is desirable to convert the analog output into photon counts in order to achieve quantitative imaging ability.

### SUMMARY OF THE DISCLOSURE

The present disclosure addresses the aforementioned and other drawbacks by providing a method for quantitative molecular imaging using an analog photodetector. The method includes receiving, with a processor, output signal data from an analog photodetector; converting the output signal data to photon count data using the processor by: receiving calibration data with the processor, wherein the calibration data relate gray values in the output signal data to a number of detected photoelectrons for the analog photodetector; converting the output signal data to photoelectron count data using the calibration data; converting the photoelectron count data to photon count data using a probability of converting photons into photoelectrons; and outputting the photon count data using the processor.

### BRIEF DESCRIPTION OF THE DRAWINGS

FIG. 1 shows an example of an eSLAM system with built-in quality control according to various aspects of the present disclosure.

FIG. 2 shows examples of designs and binary choices of molecular optical sectioning microscopy according to various aspects of the present disclosure.

FIG. 3 shows an example comparison of example pSLAM and eSLAM systems according to various aspects of the present disclosure.

FIG. 4 shows example image characteristics according to various aspects of the present disclosure.

FIG. 5 shows example response graphs in eSLAM according to various aspects of the present disclosure.

FIG. 6 shows an example quantitative analysis on multimodal/multicolor signals according to various aspects of the present disclosure.

FIG. 7 shows an example overview of PCEP calibration and image processing in eSLAM according to various aspects of the present disclosure.

FIG. 8 shows an example quantitative analysis according to various aspects of the present disclosure.

FIG. 9 shows example in situ absolute measurements of PDRs using stable illumination according to various aspects of the present disclosure.

FIG. 10 shows targeting of temporal window of signal collection according to various aspects of the present disclosure.

FIG. 11 shows characteristic features of PCEP according to various aspects of the present disclosure.

FIG. 12 shows visualized illumination fields according to various aspects of the present disclosure.

FIG. 13 shows PCEP calibration according to various aspects of the present disclosure.

FIG. 14 shows detection sensitivity and PDR according to various aspects of the present disclosure.

FIG. 15 shows an example measurement of point spread function of eSLAM according to various aspects of the present disclosure.

FIG. 16 shows an example of quantitative biological imaging by eSLAM according to various aspects of the present disclosure.

FIG. 17 shows single-frame THG images of osteocytes according to various aspects of the present disclosure.

FIG. 18 shows an example shading correction according to various aspects of the present disclosure.

FIG. 19 shows an example high dynamic range PDR according to various aspects of the present disclosure.

FIG. 20 shows an example of photon counting using binomial fitting according to various aspects of the present disclosure.

FIG. 21 shows examples of fluorescence lifetime accuracy according to various aspects of the present disclosure.

FIG. 22 shows example impulse response functions according to various aspects of the present disclosure.

FIG. 23 shows estimated photon counts according to various aspects of the present disclosure.

FIG. 24 shows NADH concentration-dependent experiments according to various aspects of the present disclosure.

FIG. 25 shows an example image according to various aspects of the present disclosure.

FIG. 26 shows an example compatibility verification of the photon counting method according to various aspects of the present disclosure.

FIG. 27 shows the effect of signal window size according to various aspects of the present disclosure.

FIG. 28 shows the effect of ROI selection according to various aspects of the present disclosure.

FIG. 29 shows the effect of ROI selection according to various aspects of the present disclosure.

FIG. 30 is a flowchart of an example method for converting analog photodetector output signal data to quantitative photon count data in accordance with some examples described in the present disclosure.

FIG. 31 is a block diagram of an example PCEP system for converting analog photodetector output signal data to quantitative photon count data.

FIG. 32 is a block diagram of example components that can implement the system

### DETAILED DESCRIPTION

Described here are systems and methods for quantitative, reproducible, and standardized molecular imaging. For high-signal-rate molecular microscopy, analog photodetectors are used to detect multiple photons per excitation cycle. As noted above, achieving quantitative imaging with analog photodetectors is a challenge because their output is related to many settings such as the gain voltage, the quantum efficiency of the target wavelength, the connected amplifier or attenuator, and so on. For instance, if the same analog photodetector is used to detect the same photon input, but with different settings, then its output will be different.

The disclosed systems and methods overcome these drawbacks by providing techniques for the conversion of analog photodetector output to photon counts, which can encode information related to local molecular concentrations within a sample. In general, the systems and methods in the present disclosure provide a pixelating with concentration encoded photoelectrons (PCEP) framework for converting the analog signal outputs from an analog photodetector to quantitative photon count data. As an example, Poisson photon statistics are used to describe the theoretical distribution of detected photoelectrons. Analog signal output expressed as image pixel gray values can be correlated to the number of detected photoelectrons by a series of either power-dependent or concentration-dependent experiments conducted on homogeneous standard solutions. This defines a relationship between pixel gray values and the number of detected photoelectrons for a given instrument, which can then be used in subsequent experiments to convert analog output signals to quantitative photoelectron count data. The photon counts can then be calculated using the probability of converting photons into photoelectrons.

In some non-limiting aspects of the present disclosure, a practical and accurate photon counting method using binomial fitting is proposed for analog detectors, which enables quantification of a large dynamic range from the detection limit to saturation. This photon counting method using binomial fitting does not require expensive acquisition and computation resources, but instead is capable of using only the gray-scale image based on the integrated signal. The conversion of analog signals to photon counts unifies the unit of measurement and enables comparisons across different systems, different channels of the same system, and different detection wavelengths and gains for the same detector. A new platform for employing analog photodetection is therefore provided, which has single-pulse per pixel imaging capability, dual-channel fluorescence lifetime imaging capability, and photon counting quantification capability. However, in other implementations, photon counting may be performed using Poisson photon optics without binomial fitting.

For high-signal-rate molecular microscopy using an analog photodetector to detect multiple photons per excitation cycle, the conversion of analog output to photon counts encoded with local molecular concentrations is advantageous for quantitative imaging, but has not been available with existing approaches. To enable this ability, the disclosed systems and methods implement a method of pixelating with concentration-encoded photoelectrons (PCEP) based on imaging of standard homogeneous samples (e.g., fluorophore solutions) and a mathematical model of Poisson photon statistics. For example, a method of PCEP can be implemented based on “imaging” standard dye/fluorophore solutions and a mathematical model of Poisson photon statistics. Using this method, the quantification with well-defined dynamic range across different types of photodetectors from different setups is provided, in addition to quantification and correction of the channel crosstalk for multichannel or multispectral imaging systems. For instance, photomultiplier tube (PMT) outputs can be converted to photon counts to effectively achieve photon counting over a wide dynamic range. In this way, the conversion to photon counts for the same PMT under different gain settings can be realized, in addition to enabling the comparison across different types of PMTs from different setups due to the use of converted photon counts as the quantification standard. These disclosed techniques enable analog photodetectors in high-signal-rate quantitative molecular imaging of label-free or labeled samples.

Although the disclosed systems and methods are described with examples in nonlinear optical imaging and linear wide-field field imaging, the disclosed methodology can be extended to other molecular imaging situations where sensitive photodetectors such as PMT and EMCCD are employed.

In other aspects of the present disclosure, the PCEP techniques implement a quality control solution that engages a set number of available imaging subtasks for an imaging system with minimal calibration procedures. For instance, all of the available subtasks for an imaging system can be engaged in the quality control procedure. As a non-limiting example, in simultaneous label-free autofluorescence multi-harmonic (SLAM) microscopy, all 15 subtasks (or a subset of relevant subtasks) listed in Table 1 can be engaged.

TABLE 1
‘Idealized’ design of eSLAM to classify quality control subtasks of live-cell fluorescence
imaging and reduce 15 isolated subtasks to a minimum effort of 3 independent subtasks.

| Subtask | Classification | Reason for designated classification |
|---|---|---|
| Reproducible sample | Irrelevant | No sample preparation for label-free imaging of living |
| preparation | | specimens that preserves physiology |
| Minimal interference from | Irrelevant | Auto-fluorescence acquired as signal in label-free imaging |
| auto-fluorescence | | (rather than background in fluorescence labeled imaging) |
| Aberration-free chromatic co- | Irrelevant | Simultaneous multicolor signal detection at single-band |
| registration | | excitation that guarantees this co-registration |
| Negligible out-of-focus | Irrelevant | Strength of multiphoton microscopy that needs validation |
| background | | only at large imaging depths |
| Real-time monitoring of | Irrelevant | Existence of an inline indicator in nonlinear optical imaging |
| phototoxicity | | (elevated auto-fluorescence during time-lapse imaging) to |
| | | monitor phototoxicity |
| Stable illumination | Independent | One constituent of PCEP for Poisson noise-limited detection |
| | | and flat-field illumination |
| Poisson noise-limited | Independent | One constituent of PCEP to enable in situ absolute |
| detection | | measurement of photo-detection using a bulk fluorophore |
| | | solution |
| Flat-field illumination | Independent | One constituent of PCEP to enable uniform illumination |
| | | across field-of-view of microscope objective |
| Accurate correction of color | Dependent | One-time-calibrated photon crosstalk matrix to correct |
| bleed-through or cross-talk | | bleed-through in multicolor or dual-color ratiometric |
| | | imaging, and the calibration is ensured by PCEP calibrations |
| Diffraction-limited lateral- | Dependent | One-time-calibrated point spread function ensured by PCEP |
| axial resolution | | calibrations |
| Real-time image processing | Dependent | Shading correction for different imaging modalities ensured |
| and visualization | | by PCEP calibrations; real-time display free of image |
| | | reconstruction |
| Repeatable stage positioning | Feasible | Optional calibration for large-field stitched imaging; not |
| | | required for PCEP calibration and stitching-free imaging |
| | | applications |
| Objective image quality and | Feasible | Quality assessment by representing each pixel as effective |
| error assessment | | photons (with squared root as error according to Poisson |
| | | statistics) |
| Standard image format and | Feasible | Universal pixel representation by effective photons (e.g., |
| metadata for storage | | 0.001-2048 range); related metadata in photo-detection may |
| | | be simplified |
| Real-time monitoring of photo- | Feasible | Rapid acquisition of “noise” images using low-power |
| bleaching | | illumination or low-concentration fluorescence labeling |

In Table 1, the following classifications are defined: irrelevant, for unnecessary subtasks if eSLAM is chosen for imaging; independent, for necessary subtasks for quality control by PCEP; dependent, for subtasks that only need one-time effort if PCEP calibration is routinely performed; and feasible, for subtasks that are simplified by PCEP. The first two rows list sample-dependent subtasks with no definitive measurable, the next three rows list technically challenging subtasks, the next three rows list independent subtasks, and the final seven rows list other subtasks.

These 15 are based on simultaneous label-free autofluorescence multi-harmonic microscopy (SLAM) that integrates four modalities of two- and three-photon excited fluorescence and harmonics (2 PF, SHG, 3 PF, and THG). This system can be adapted to a portable system (pSLAM) and an extended version (eSLAM) that incorporates a stabilized (>2000 hr) fiber supercontinuum source, as described below in more detail. The corresponding label-free aspect not only renders two sample-dependent subtasks irrelevant, but also mitigates plausible phototoxicity during time-lapse imaging by inline monitoring the intrinsic phototoxicity indicator of elevated auto-fluorescence, which has been linked to impaired cell cloning. Also, the use of multiphoton illumination ensures negligible out-of-focus background, while the resulting simultaneous multicolor detection at single-band excitation ensures aberration-free chromatic co-registration. In this way, only 10 subtasks remain relevant, as illustrated in Table 1.

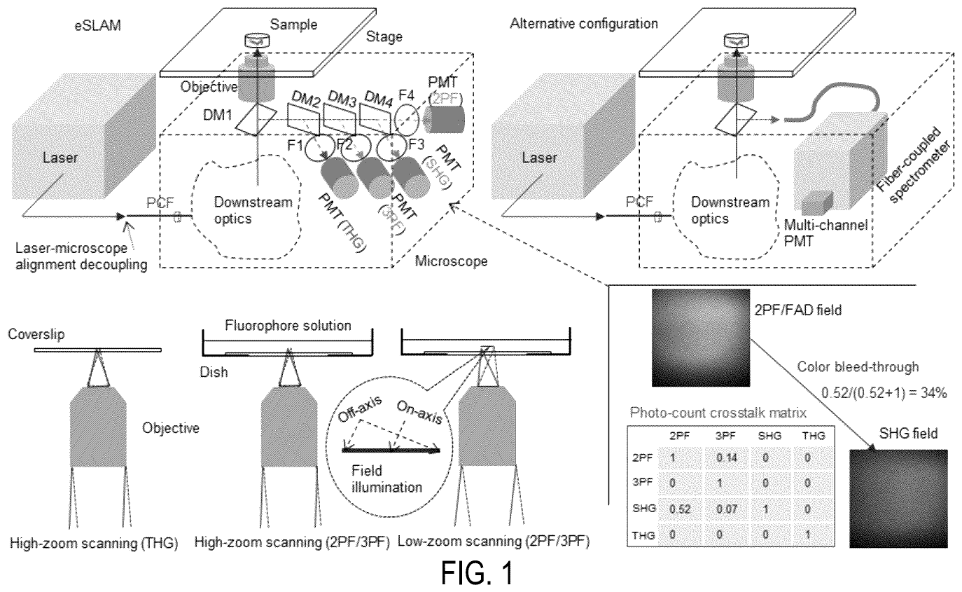

FIG. 1 shows a schematic of an eSLAM system with built-in quality control. The inverted microscope includes a source femtosecond laser, a spectrum-broadening module based on photonic crystal fiber (PCF), subsequent relaying optics with a mechanical stage to perform high/low-zoom 2 PF/3 PF ‘imaging’ of a fluorophore solution at 15±5 μm depth and THG imaging of coverslip interface (bottom left), and photo-detection paths with specific dichroic mirrors (DM) and optical filters (F) corresponding to 4 modalities (THG, 3PF/NADH, SHG, and 2PF/FAD), along with an alternative configuration with optical fiber-coupled spectral detection module (upper right). The optical alignment of the laser and the microscope is decoupled (i.e., laser-microscope alignment decoupling) because the misalignment of the former can be easily detected by the altered output spectrum of the PCF. Inset: measured bleed-trough from illumination field of 2PF/FAD to that of SHG and resulting photon crosstalk matrix for 4 modalities.

With the deterministic (coherent) spectral broadening in a single-mode fiber that guarantees stable illumination via laser-microscope alignment decoupling, as illustrated in FIG. 1, this quality control tool can be realized using diverse elements of photo-detection not directly related to imaging quality control, as illustrated in Table 2.

TABLE 2
Diverse elements of photo-detection (green) integrated in this study
that are not directly related to microscopy quality control.

| Poisson-noise- | | | | |
|---|---|---|---|---|
| limited detection | Photodetector | Sample | Illumination | Purpose |
| Varying- | In situ analog | NADH | Two-photon | Advantage of PC over |
| concentration | PMT vs. PC PMT | solutions | | analog detection for weak |
| | | | | signals |
| No | PC PMT | Fluorophore | Multi-photon | Absolute measurement of |
| | | solutions | | excitation molecular cross- |
| | | | | section |
| Sample | In situ analog | FL-labeled | Two-photon | Advantage of PC over |
| inhomogeneity | PMT vs PC PMT | polymer fibers | | analog for weak signals via |
| | | | | excess noise |
| Sample | In situ analog | FL-labeled | Two-photon | Advantage of SiPM over |
| inhomogeneity | PMT vs SiPM | pollen grain | | analog PMT for strong |
| | | | | signals via a SNR model |
| Varied frame | In situ analog | Fluorescent | Two-photon 1 | Advantage of SiPM over |
| number | PMT vs SiPM | test slide | pulse/pixel | analog PMT for strong |
| | | | | signals via PTC |
| Varying-power | Diverse cameras | No | One-photon | Photon-resolving in camera- |
| | | | uniform light | like detector via PTC |
| Varying-power | Superconducting | No | One-photon | Photon-resolving in point- |
| | transition edge | | testing light | like detector by low read |
| | sensors | | | noise; quantum information |
| | | | | applications |
| Varying-power | sCMOS camera | No | One-photon | Photon-resolving in camera- |
| | | | uniform light | like detector by low read |
| | | | | noise |

In Table 2, FL refers to fluorescence, NADH refers to reduced nicotinamide adenine dinucleotide, PC refers to photon counting, PMT refers to a photomultiplier tube, PTC refers to photon transfer curve, sCMOS refers to scientific complementary metal-oxide-semiconductor, SiPM refers to a silicon photomultiplier tube, and SNR refers to signal-to-noise ratio.

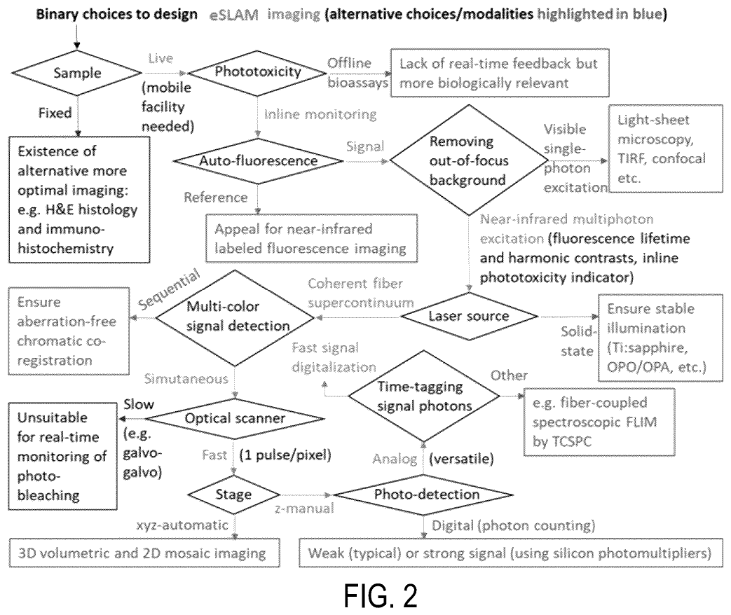

PCEP integrates 3 independent subtasks to image fluorophore solutions with known concentrations, while making the other 7 subtasks dependent or feasible, as noted in Table 1. This leads to a surprisingly simple procedure to monitor hardware failure or aging in SLAM-based imaging. Also, PCEP is validated by other forms of molecular optical sectioning microscopy with point-like or camera-like photo-detection (described below in more detail), demonstrating its broad applicability to alternative designs, as illustrated in FIG. 2 showing diverse designs and binary choices of the molecular optical sectioning microscopy alternative to eSLAM. This may unify often proprietary image pixel representations from different microscopy vendors with a unit of absolute measurement (effective photon) directly related to the local concentration of a (labeled) biomolecule of interest.

Advantageously, the systems and methods described in the present disclosure improve the quantitative aspect of molecular imaging by enabling absolute measurements (e.g. local concentration, fluorescence lifetime, etc.) and ratio-metric measurements (e.g. optical metabolism, FRET, etc.), removing spectral crosstalk or bleed-through in multi-spectral molecular imaging, and monitoring photo-bleaching of fluorophores. As another advantage, the systems and methods described in the present disclosure improve the reproducible aspect of molecular imaging by correcting uneven field illumination, simplifying imaging metadata, taking photo-toxicity into consideration, and optimizing the platform of molecular imaging. As yet another advantage, the systems and methods described in the present disclosure improve the quality control aspect of molecular imaging by testing simple phantoms, enabling device/modality inter-comparison, monitoring hardware failure and aging, and standardizing image format and storage.

Prior quality control technologies fail to include absolute measurement of local concentration via concentration-encoded photoelectrons regardless of detection electronic settings (gain), and the concept of noise equivalent concentration limit and photo-electron limit of photodetector per exposure. Additionally, prior quality control technologies lacked a single solution that was broadly applicable for diverse detectors, gains, exposures in different microscopes (with different irradiation pattern), or for diverse photo-detection (including photon-counting), fluorophores, fitting type (concentration vs photon order dependence of fluorophore solutions), modalities (harmonic contrasts), ROI across modality in the same laser scanning microscope. These prior quality control technologies also lacked the ability to provide crosstalk-free ratio-metric imaging and fluorescence lifetime imaging microscopy (FLIM), and the like.

Quality control in molecular optical sectioning microscopy is important for transforming acquired digital images from qualitative descriptions to quantitative data. Thus, although numerous tools, metrics, and phantoms have been developed, accurate quantitative comparisons of data from different microscopy systems with diverse acquisition conditions remains a challenge. The disclosed systems and methods provide a simple tool based on an absolute measurement of bulk fluorophore solutions with related Poisson photon statistics to overcome this obstacle. As one non-limiting example, implementing a multiphoton microscope, the disclosed systems and methods unify the unit of pixelated measurement to enable objective comparison of imaging performance across different modalities, microscopes, components/settings, and molecular targets. The application of this tool in live specimens identifies an attractive methodology for quantitative imaging, which rapidly acquires low signal-to-noise frames with either gentle illumination or low-concentration fluorescence labeling.

### Methods

### Optical Setup of ESLAM

An example optical setup of an eSLAM microscopy system that can be implemented in accordance with the present disclosure is illustrated in FIG. 1. Details of the laser source are described below. The 5 MHz supercontinuum pulses from this source are sent into a 128-pixel 4f pulse shaper (femtoJock Box, BioPhotonic Solutions Inc.) to select an excitation band of 1110±30 nm. The spectrally selected pulses are then raster scanned by a resonant mirror (10×10 mm, 1592 Hz line rate, EOCP) and a galvanometer mirror (GVS011, Thorlabs), and finally focused by a microscope objective (UAPON 40XW340, N.A.=1.15, Olympus) with up to ˜35 mW average power on the sample. A pair of identical achromatic doublets (AC254-050-C-ML-f=50 mm, Thorlabs) and another pair of different achromatic doublets (AC254-030-C-ML-f=30 mm, AC508-100-C-ML-f=100 mm, Thorlabs) are used for 4f telecentric resonant-galvanometer beam steering, while the latter also expanded the beam to fill the back focal pupil plane of the objective (Ø10.35 mm). The actual/safe power on the sample can be adjusted by a neutral density (ND) filter while the corresponding pulse width can be compressed to near-transform-limited value (˜60 fs, FWHM) by the pulse shaper. Average incident power at the sample plane can be measured by a microscope slide power meter (S175C, Thorlabs). The photo-detection of eSLAM follows that of SLAM except for the replacement of photon-counting PMTs with analog PMTs. The whole system can function as an inverted multiphoton microscope.

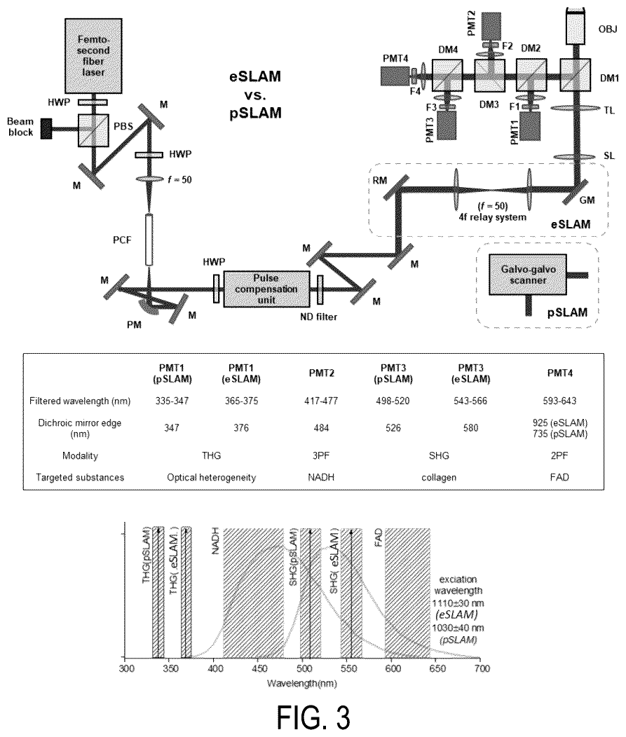

FIG. 3 illustrates a detailed optical schematic of portable SLAM (pSLAM) and eSLAM (top) with 4 detection colors/channels (middle) that include NADH and FAD measurements (bottom). The inverted microscope includes a nonlinear fiber spectrally broadened laser source with central wavelength of 1030-nm (pSLAM) or 1110-nm (eSLAM) and a pulse compensation unit (spatial light modulator-based pulse shaper for eSLAM and prism-based pulse compressor for pSLAM), while detection colors of THG, 3PF, SHG, and 2PF are spectrally separated according to the emission spectra of NADH and FAD (bottom). In FIG. s2, HWP refers to half wave plate; PBS refers to polarizing beam splitter; M refers to mirror; PCF refers to photonic crystal fiber; PM refers to parabolic mirror; ND refers to neutral density; RM refers to resonant mirror; GM refers to galvo mirror; SL refers to scan lens; TL refers to tube lens; DM refers to dichroic mirror; OBJ refers to objective; F refers to filter; and PMT refers to photomultiplier tube.

### Signal Acquisition and Processing (General)

The pulse repetition rate of the laser source (40 MHz) can be divided to 10 MHz by a frequency divider (PRL-260BNT, Pulse Research Lab) and distributed by a fanout line driver (PRL-414B, Pulse Research Lab), and then used as the master clock to synchronize the resonant mirror and subsequent signal acquisition. For the resonant mirror, the active acquisition length was designed to occupy the central 65% of the sinusoidal line profile (spatial fill fraction), with one pulse per pixel per frame (i.e. pixel dwell time 0.2 μs). The PMT-detected 2 PF and 3 PF signals were first sent to high-speed current-to-voltage conversion amplifier unit (C5594-12, Hamamatsu) with 1.5 GHz cutoff frequency. The converted voltage signals were then digitized by a 2 GHz dual-channel high-speed digitizer (ATS9373, AlazarTech). For high dynamic range calibration of photo-detection using a NADH/FAD solution, a 20 dB attenuator was connected after the amplifier to match the range of digitizer input voltage (±400 mV). The signals from SHG and THG modalities were amplified by a 60 MHz bandwidth amplifier (TIA60, Thorlabs) and digitized by a 125 MS/s digitizer (ATS9440, AlazarTech).

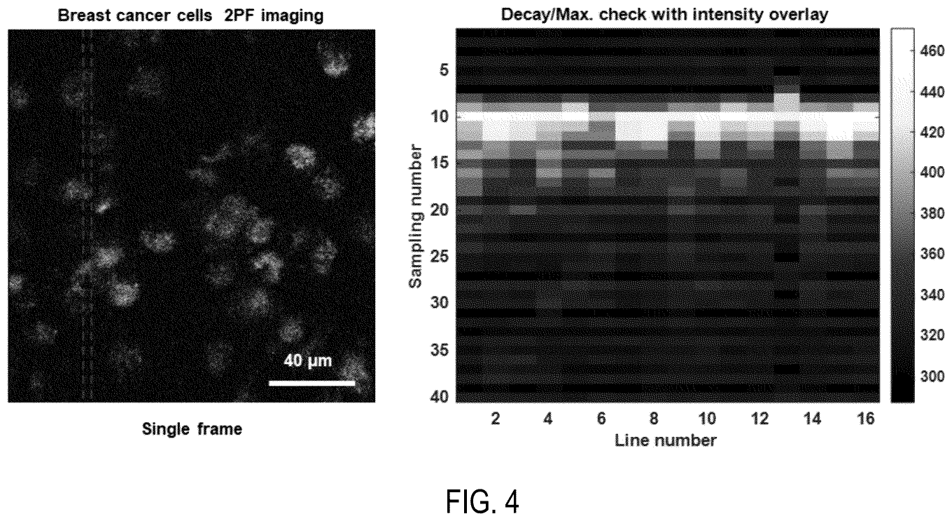

A GPU (Geforce RTX 2080, NVIDIA) enabled real-time image display and accelerated raw data process. The design supported a maximal frame (1024 pixel×1024 pixel) rate of 3 Hz by bidirectional resonant scanning but was limited to ˜1.7 Hz by the storage of rapidly digitized 2 PF and 3 PF modalities. At 5 MHz repetition rate and 2 GS/s sampling rate, there are 400 sampling points between pulses. Because the fluorescence lifetime of FAD or NADH is less than 10 ns (20 sampling points), at least 95% of the data points are noise points. To avoid these noise points, the position of the maximum value within each line of fast scan can be found by superimposing the raw data of all the pixels in the line. Then, the custom data points near the maximum value position (time-gated window) can be extracted using a custom LabVIEW-based GUI with 40 data points per pulse, 9 before the maximum value and 30 after the maximum value (FIG. 4). In particular, FIG. 4 shows a demonstration of time-gated window with 40 sampling points. (Left) Single-frame 2 PF image of unlabeled breast cancer cells with a narrow red dotted area of interest. (Right) Superimposition of all the pixels within each line of this area of interest reveals a time-gated window with 40 sampling points, in which the maximum value is set at the 10th sampling point. By implementing this algorithm in the GPU, most noise points were removed before storage.

Before performing PCEP, the offset values are removed from all pixels of field illumination images. For the vary-C (varying-P) experiment, the offset values are obtained from a field illumination image of blank control solution of C=0 (or a fluorophore solution at P=0). Then, parameter ƒC (or ƒP) is determined by the single-parameter linear fit between experimental (Mean/STD)² from a small FOV or a ROI (or super-pixel) of field illumination images and C (or Pⁿ). This produces an experimental SNR versus N̅ relation (Eqn. (2) or Eqn. (3) below) to compare with the theoretical relation with known m (Eqn. (1) below), resulting in a measured PDR often with a distinguishable lower end that exhibits disagreement.

### Signal Acquisition and Processing (FLIM)

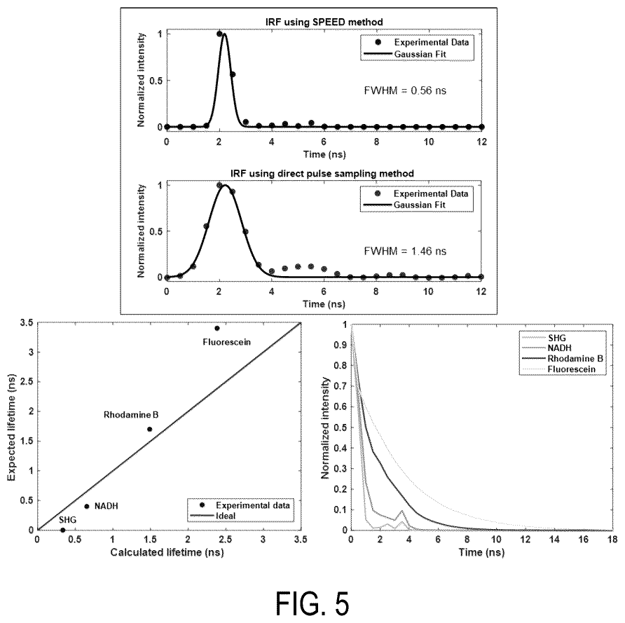

To validate the FLIM capability of eSLAM, the lifetimes of SHG (˜0.0 ns), NADH in 1M HEPES (˜0.4 ns), Rhodamine B in water (˜1.7 ns), and Fluorescein in ethanol (˜3.4 ns) were tested using computational photon counting by employing the single- and multi-photon peak event detection (SPEED) algorithm. FIG. 5 shows (Top) Impulse response functions (IRF) in eSLAM based on SHG of urea crystal using SPEED method and the direct pulse sampling method, with Gaussian fits to estimate the full-width-half-maximum in ns; (Bottom) Calculated lifetimes and expected values for four different fluorophores/harmonophores (left) and fluorescence decay curves for each calibration fluorophore/harmonophore (right). For short lifetimes, such as NADH and SHG, a reflection from the amplifier may be present a few ns after photon arrival and may register as a photon count. Specifically, Rhodamine B and Fluorescein were used to calibrate the 2 PF modality, NADH was used to calibrate the 3 PF modality, and the temporal IRF of the system was determined by SHG imaging of a urea crystal (FIG. 5, top). The estimated fluorescence lifetimes approximated the known values (FIG. 5, bottom). However, low fluorescence lifetimes (such as NADH and SHG) were biased slightly higher due to the limited bandwidth of collection electronics, and longer fluorescence lifetimes (Rhodamine B and Fluorescein) were biased to lower values, likely due to the low probability of collecting and properly time-tagging later-arriving photons when using one laser pulse per pixel and inferring the laser pulse synchronization. The IRF of photo-detection had a full-width-half-maximum (FWHM) of 0.56 ns, slightly higher than previously reported IRFs estimated using SPEED which used a different PMT and faster digitization rates (0.32 ns IRF with 3.2 GS/s ADC28, 0.23 ns IRF with 5 GS/s ADC29). Despite these biases, existing eSLAM sufficiently revealed relative changes in fluorescence lifetime over the range of interest for NADH and FAD.

Both SPEED and PCEP were used to quantify the average number of photons per pulse using different concentrations of NADH from 0.5 to 20 mM. Data was analyzed to determine the average number of photons per pulse per 1 mM NADH, resulting in 0.060 photons/pulse/1 mM NADH for SPEED and 0.068 photons/pulse/1 mM NADH for PCEP with a strong linear correlation (R2=0.998). A small percentage (<10%) of photon counts are being missed at the higher photon rates of the experimental data using SPEED, leading to values that are biased slightly lower due to the finite dead time of the system (˜1.0 ns, or twice the sampling rate). The SPEED method requires high sampling rate (>1 GS/s with high consumption on acquisition and computation) to restore the original signal and time tag detected photons for FLIM imaging, whereas PCEP simply uses the integrated/averaged signal collected at lower digitization rates and supports up to 23 effective photons per pulse but does not time-tag the detected photons. The presented eSLAM system is capable of both SPEED and PCEP for quantification due to its versatile design.

### Photon Crosstalk Matrix

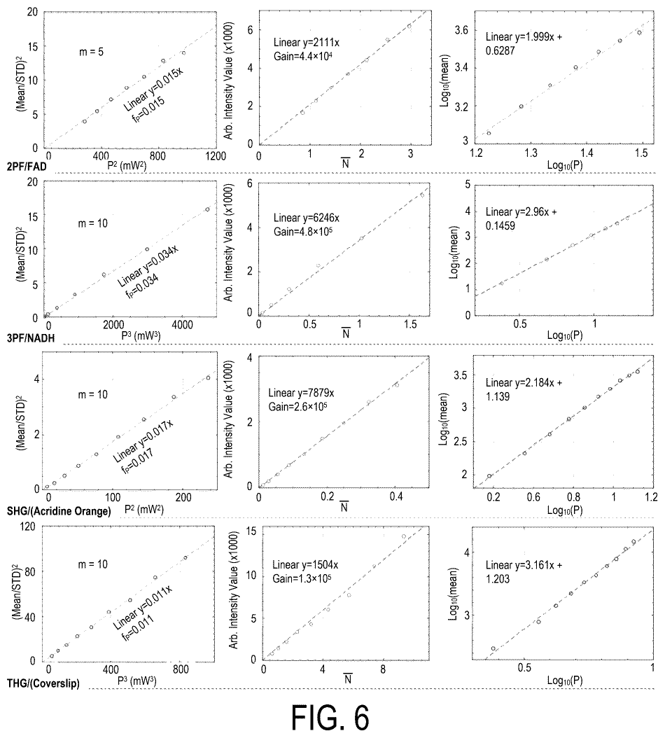

The varying-P experiments for 4 different modalities (2 PF, 3 PF, SHG, and THG) not only calibrated the relation between pixel arbitrary intensity values and effective photons within individual modalities (FIG. 6), but also produced the color bleed-through across these modalities due to the simultaneous signal acquisition by eSLAM. In FIG. 6, the left panels show determination of ƒP from single-parameter linear fit between experimental eSLAM (mean/STD)² and Pⁿ in 2 PF, 3 PF, SHG, and THG “imaging” of a small field-of-view, which involves 50-mM FAD (2 PF), 10-mM NADH solutions (3 PF), 1 mg/mL acridine orange solution that mimics a homogeneous SHG sample (SHG), and coverslip surface (THG), respectively; the middle panels show related conversion of arbitrary intensity values of PMT analog output to effective photons corresponding to the 4 imaging modalities at specific PMT gains; and the right panels show mean (in arbitrary intensity value) versus P (in mW) in the log-scale that is consistent with the nonlinear photon order of 2 (2 PF, SHG) or 3 (3 PF, THG). The input signal of a given modality and related bleed-through to other modalities (columned percentages in FIG. 1, Inset) were qualified using the converted effective photons from the arbitrary intensity values (FIG. 6, middle panels) over the full field-of-view of illumination (FIG. 1, images). This removed any dependence of the resulting crosstalk matrix (FIG. 1, Inset) on illumination power, PMT gain, or other device settings (which would be present if the arbitrary intensity value were used). Although the calibration was performed at specific PMT gains, the arbitrary intensity values at different gains can be calculated by the ratio of actual versus calibrated gain to produce a look-up table of arbitrary-intensity-value-to-effective-photon conversion. Despite this complexity, the photon crosstalk matrix remains constant for different PMT gains. It can be varied by changing the optical filters and dichroic mirrors of photo-detection module to minimize signal crosstalk (FIG. 1). The observed small crosstalk between 3 PF and 2 PF modalities (FIG. 1, Inset), not expected from the spectrally overlapped emission of NADH and FAD (FIG. 3), is due to clipping-assisted dual-fluorophore sensing.

The photon crosstalk matrix in FIG. 1 was then divided by the total applied load in each modality to obtain the transfer function K:

$$K = [ \begin{matrix}0.657 & 0.112 & 0 & 0 \\ 0 & 0.828 & 0 & 0 \\ 0.343 & 0.060 & 1 & 0 \\ 0 & 0 & 0 & 1\end{matrix} ]$$

and the inverse matrix K⁻¹:

$${K}^{- 1} = [ \begin{matrix}1.523 & - 0.206 & 0 & 0 \\ 0 & 1.207 & 0 & 0 \\ - 0.523 & - 0.0012 & 1 & 0 \\ 0 & 0 & 0 & 1\end{matrix} ]$$

Applying K⁻¹ to each pixel of eSLAM images after arbitrary-intensity-value-to-effective-photon conversion results in crosstalk-compensated images without field correction.

### Overview of Calibration and Data Processing in ESLAM

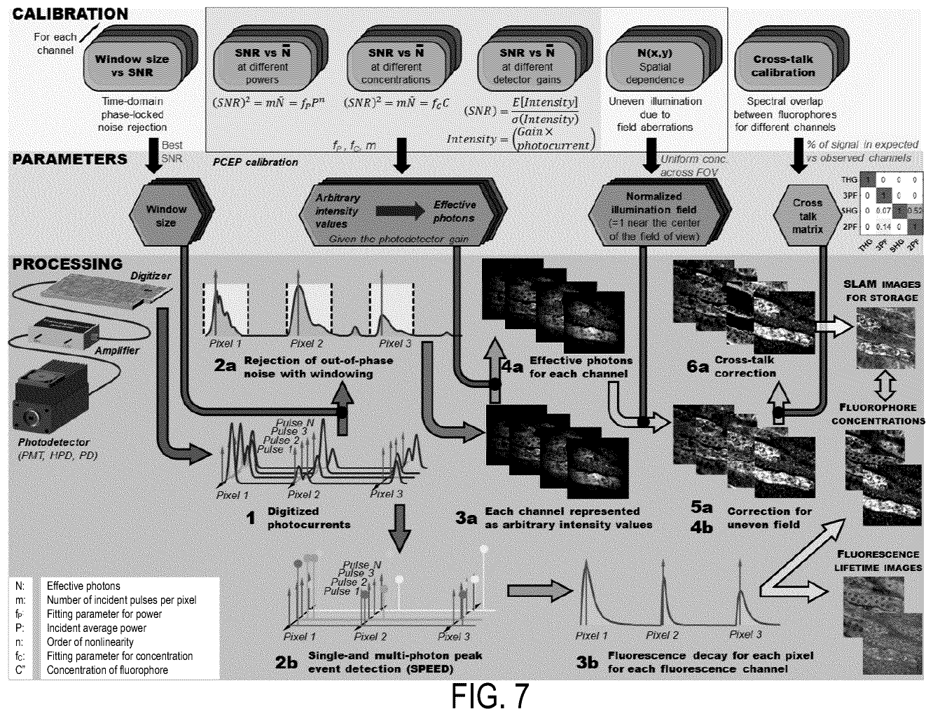

Software components of eSLAM have been discussed individually. With PCEP-based calibration that determine various data processing parameters, the digitized analog outputs of PMTs from a biological sample can be ultimately converted to effective photon-pixelated multimodal eSLAM images, and related fluorescence lifetime images and concentration images of targeted fluorophores (FIG. 7). Thus, eSLAM can serve as a starting point of quantitative imaging for diverse designs of molecular optical sectioning microscopy (FIG. 2).

### Other Microscopes and Stage Focusing

As noted above, in addition to eSLAM, the methods described in the present disclosure can be applied to other microscopy and imaging systems, including SLAM, pSLAM, and traditional multiphoton microscope (MPM). The main independent parameters of SLAM, pSLAM, and multiphoton laser-scanning microscopes are compared with those of eSLAM in Table 3 below.

TABLE 3
Performance comparison among multiphoton microscopes in NADH/FAD imaging under
safe illumination conditions (SLAM for theoretical comparison only).

| | | | Comparative | | | | | |
|---|---|---|---|---|---|---|---|---|
| Microscope | SLAM | | MPM | | pSLAM | | eSLAM | |
| Laser source | Custom fiber | | Regular solid-state | | Custom spectrally | | Custom fiber | |
| | supercontinuum | | Ti:sapphire laser | | broadened laser | | supercontinuum | |
| Illumination band | 1110 ± 30 nm | | 750 ± 5 nm (NADH) | | 1030 ± 30 nm | | 1110 ± 30 nm | |
| | | | or 900 ± 5 | | | | | |
| | | | nm (FAD) | | | | | |
| Pulse repetition rate | 10 | MHz | 80 | MHz | 0.83 | MHz | 5 | MHz |
| Pulse width on | 60 | fs | 200 | fs | 60 | fs | 60 | fs |
| sample (FWHM) | | | | | | | | |
| Water immersion | UAPON40XW340 | | XLPLN25XWMP2 | | UAPON40XW340 | | UAPON40XW340 | |
| microscope | (Olympus), NA | | (Olympus), NA | | (Olympus), NA | | (Olympus), NA | |
| objective | 1.15 | | 1.05 | | 1.15 | | 1.15 | |
| Illumination P on | 20 | mW | 15 | mW | 2.4 | mW | 16.8 | mW |
| sample | | | | | | | | |
| Optical scanner | Galvo-Galvo | | Galvo-Galvo | | Galvo-Galvo | | Resonant-Galvo | |
| Fast scan line rate | 140-350 Hz, | | 320 Hz, | | 340 Hz, | | 1592 Hz, | |
| and readout mode | unidirectional | | unidirectional | | bidirectional | | bidirectional | |
| Software control | LabVIEW | | LabVIEW | | ScanImage | | LabVIEW | |
| PMT − 2PF (n = 2), | H7421-40 | | H7422P-40 | | P2101 (Thorlabs), | | H7422A-40 | |
| quantum efficiency | (Hamamatsu), | | (Hamamatsu), | | 40% | | (Hamamatsu), | |
| | 31.6% | | 42.1%, 43.2% | | | | 41.4% | |
| PMT − 2PF (n = 3), | H7421-40 | | Not applicable | | P2101 (Thorlabs), | | H7422A-40 | |
| quantum efficiency | (Hamamatsu), | | | | 44% | | (Hamamatsu), | |
| | 31.8% | | | | | | 42.1% | |
| PMT − SHG (n = 2), | H7421-40 | | Not applicable | | P2101 (Thorlabs), | | H7422A-40 | |
| quantum efficiency | (Hamamatsu), | | | | 44% | | (Hamamatsu), | |
| | 33.4% | | | | | | 16.8% | |
| PMT − THG (n = 3), | H7421-40 | | Not applicable | | P2101 (Thorlabs), | | H7422A-40 | |
| quantum efficiency | (Hamamatsu), | | | | 24.2% | | (Hamamatsu), | |
| | 20.4% | | | | | | 42.4% | |
| Frame size (pixel × | 700 × 700 | | 512 × 512 | | 1024 × 1024 | | 1024 × 1024 | |
| pixel) | | | | | | | | |
| Field-of-view | 300 × 300 | μm² | 128 × 128 | μm² | 300 × 300 | μm² | 250 x 250 | μm² |
| (imaging) | | | | | | | | |
| Pixel dwelling time | 5-12 | μs | 4 | μs | 1.2 | μs | 0.2 | μs |
| Pulses/pixel/frame (m) | 50-120 | | 320 | | 1 | | 1 | |
| Frame acquisition | 2-5 | s | 1.6 | s | 1.5 | s | 0.33 | s |

| time | | | | |
|---|---|---|---|---|
| NADH and FAD | Simultaneous | Sequential | Simultaneous | Simultaneous |
| imaging | | | | |
| Sensitivity: EP/ | 0.21 | 0.27 | 0.35 | 1.0 |
| pulse (10-mM | | | | |
| NADH solution) | | | | |
| Throughput: EP/μs | 2.1 | 22 | 0.29 | 5.1 |
| (10-mM NADH | | | | |
| solution) | | | | |
| Sensitivity: | 0.10 | 0.13 | 0.65 | 0.29 |
| EP/pulse (10-mM | | | | |
| FAD solution) | | | | |
| Sensitivity: EP/μs | 1.0 | 10 | 0.54 | 1.4 |
| (10-mM FAD | | | | |
| solution) | | | | |

In Table 3, EP refers to effective photon. The illumination power P is the upper limit tested on diverse live cell/tissue samples without observing the phototoxicity of elevated auto-fluorescence during time-lapse imaging.

The wide-field inverted TIRF microscope built upon a Zeiss Axiovert 200M microscope is equipped with an oil immersion microscope objective (63x, NA 1.4) and a cooled Photometrics 512 Evolve EMCCD camera to image the fluorescence of single molecules or a thin (<200 nm typically) specimen.

The stage focusing of these microscopes was used for PCEP to visualize the illumination field in a bulk fluorophore solution inside a 35-mm glass (coverslip) bottom dish (FIG. 1). For all laser-scanning inverted microscopes (e.g., eSLAM, pSLAM, and MPM), the interface between coverslip and the solution was detected by continuous low-zoom fluorescence imaging while manually positioning a microscope stage. Then, the illumination plane was placed ˜10 μm inside the solution using the stage. For the TIRF microscope, this interface was first marked with fiducial lines by a diamond knife and detected by the built-in bright-field imaging of the same microscope. The bright-field imaging was then switched to TIRF imaging while the corresponding illumination field was placed ˜10 μm inside the solution manually using the built-in stage of the microscope.

### Example 1

In an example study, the PCEP techniques described in the present disclosure were evaluated using bulk prepared solutions, animal tissue, and cell cultures.

NADH (Grade I, Sigma) and FAD (94% dry wt., ThermoFisher Scientific) were dissolved in a 1 M HEPES buffer to maintain a stable pH. Rhodamine B and acridine orange were dissolved in sterile water. Fluorescein was dissolved in 100% ethanol.

For animal studies, the internal organs were obtained from ˜3-month-old 2.8 kg laboratory female New Zealand white albino rabbits (Oryctolagus cuniculus) (Charles River Laboratories, Wilmington, MA) bearing subcutaneous rabbit mammary tumors within 10 minutes post-mortem. The excised kidneys (or hearts) were immediately submerged in sterile Ca2+/Mg2+-free 0.1 μm filter-sterilized PBS (pH 7.0-7.2) and washed from blood by changing the PBS solution 3 times. Each organ sample was manually sliced in axial and sagittal planes in sterile tissue culture dish kept on ice. Individual tissue slices were then placed onto the uncoated 35 mm imaging dishes with No. 0 coverslip and 20 mm glass diameter (MatTek, #P35G-0-20-C). The slices were incubated in 500 μL FluoroBright™ DMEM (TFS, #A1896701) supplemented with 10% FBS, 1% PSA, and 4 mM L-Glutamine solutions. Mice (C57BL/6J, Jackson Laboratory) were used to obtain ex vivo skull samples, which were imaged directly without solution-based preparation.

For cell studies, human breast cancer cells MCF7 (ATCC HTB-22) were maintained in EMEM supplemented 10% FBS, 5 μg/mL insulin and 1% penicillin streptomycin antibiotic, and grown in an incubator at 37° C. with 5% CO2. One day prior to imaging, cells were plated on poly-D-lysine coated 35 mm diameter glass-bottom imaging dishes (P35GC-0-10-C,MatTek) and incubated overnight in 2 mL of media to adhere.

### Results

Typically, the performance of a photodetector is either measured without placing it in situ (in a pre-aligned microscope with fixed optical components and alignments) or simply taken as original factory calibration without measuring over time, both of which are unsuitable for monitoring plausible failure or aging. It is thus an important progress to measure a photomultiplier tube (PMT) in situ, using homogeneous samples such as the solutions of reduced nicotinamide adenine dinucleotide (NADH) and flavin adenine dinucleotide (FAD), i.e., well-known intrinsic fluorophores in cellular metabolism. A similar experiment has allowed absolute measurement of multiphoton excitation molecular cross-section, suggesting the feasibility to correlate (encode) the concentration of a fluorophore in solution with the number of detected photons. Motivated by these studies, analog photo-detection performance was assessed by a simple in situ absolute measurement, using the illumination from a fiber supercontinuum laser with stable beam pointing, spatial mode propagation, and spectral power.

Analog photo-detection noise is composed of Poisson noise that includes the shot noise and excess noise (i.e., multiplicative noise), and non-Poisson noise that includes the additive noise. Thus, the Poisson-noise-dominated dynamic range (PDR) of a point-like analog photodetector can be determined experimentally wherever the non-Poisson noise is negligible. For detected fluorescence photons from a fluorophore solution within the PDR, the in situ measured signal-to-noise-ratio (SNR) in a small/flat-field area (e.g., several square micrometers), i.e., mean versus standard deviation (STD) of the pixelated arbitrary intensity value from PMT analog output, satisfies the Poisson statistics of:

$$\begin{matrix}SNR {\vert}_{Theory} = \frac{m \overline{N} ( signal )}{\sqrt{m \overline{N}} ( noise )} = \sqrt{m \overline{N}} , where \overline{N} = \frac{\overline{{N}_{D}}}{1 + ɛ} & ( 1 ) \\ SNR {\vert}_{experiment} = \frac{mean}{STD} {\vert}_{m} = \sqrt{{f}_{c} C} & ( 2 ) \\ SNR {\vert}_{experiment} = \frac{mean}{STD} {\vert}_{m} = \sqrt{{f}_{p} {P}^{n}} & ( 3 )\end{matrix}$$

Above, N̅_̅{̅D̅}̅ is the average signal/fluorescence photons detected by the PMT per pulse (or per excitation cycle to incorporate linear optical microscopy), ε is detector-dependent excess noise factor which is a constant for an analog PMT (20-70%) or zero for a photon-counting PMT (similar classification is applicable to array- or camera-like detectors), N̅ is the corresponding effectively detected photons with a unit of “effective photon” at equal mean and STD, m is the number of pulses per pixel within one frame or over multiple frames in one pixelated measurement, C is the concentration of a fluorophore of interest with a fitting parameter ƒC to attain mN̅ (Eqn. (1) and Eqn. (2)), and n is the order of optical nonlinear process at average power P while ƒP is the corresponding fitting parameter (Eqn. (1) and Eqn. (3)).

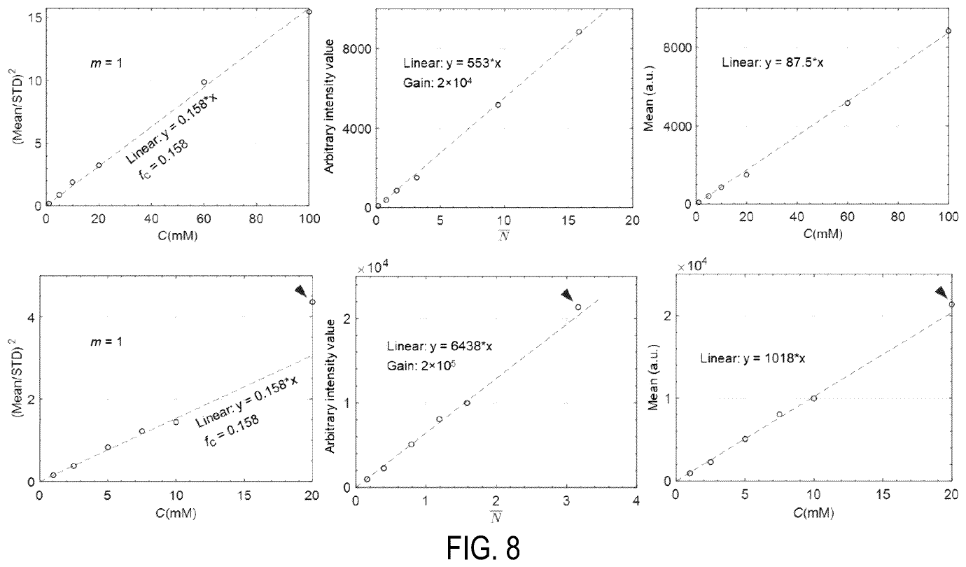

Experimentally, the illumination was focused at a shallow depth (15±5 μm) inside the solutions with a small field-of-view (FOV) of <10×10 μm², i.e., a high-zoom raster scanning through a microscope objective (FIG. 1). By varying C of NADH solutions at a constant P or by varying P on a NADH/FAD solution with constant C, these equations were tested across three laser-scanning multiphoton microscopes operated at either one pulse per pixel or hundreds of pulses per pixel (Table 3), so that each experimental point of SNR involved ≥9000 pulses. The parameter ƒC (or ƒP) can be obtained from the single-parameter linear fit between experimental (mean/STD)² and C (or Pⁿ) before signal saturation according to Eqn. (2) (or Eqn. (3)), as shown in FIG. 8 (or FIG. 6). In FIG. 8, the left panels show a determination of ƒC from single-parameter linear fit between experimental pSLAM (mean/STD)² and C in 3 PF “imaging” of 10 mM NADH solution with a small field-of-view at a low (top) and high gain (bottom); the middle panels show related conversion of arbitrary intensity values of PMT analog output to effective photons; and the right panels show mean (in arbitrary intensity value) versus C (in mM) that confirms a linear relation. Note that for figures associated with bottom panels at a high PMT gain, the (mean/STD)² vs. C plot (lower left) is more sensitive to saturated photo-detection than the other two plots (arrowheads).

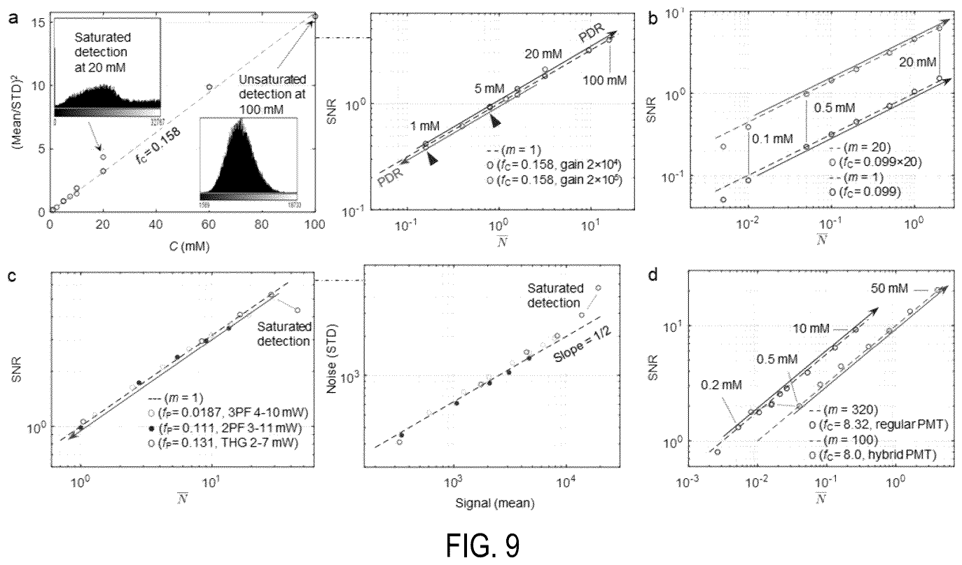

Indeed, the theoretical log-scale linear relation between SNR and N̅ (Eqn. (1)) was validated by the corresponding experimental lines (Eqn. (2) or Eqn. (3)) indicative of PDRs (FIG. 9). In FIG. 9A, Parameter ƒC obtained from single-parameter linear fit (broken line) between experimental pSLAM-3 PF (mean/STD)2 and C (NADH concentration) in two varying-C (P=2.4 mW) experiments at two different PMT gains (colored points), with unsaturated/saturated histogram at low/high gain (Insets); note that the right panel shows the corresponding log-scale PDRs from Eq. 2 (colored points and arrowed lines), in which both PMT gains attain 0.16 and 0.79 effective photon at 1 mM and 5 mM, respectively, along with prediction from Eq. 1 (broken line). FIG. 9B shows PDRs from varying-C (NADH) constant-P (16.8 mW) eSLAM (Eq. 2) at PMT gain 4.8×105 corresponding to one frame and 20 frames (colored points and arrowed lines) along with prediction from Eq. 1 (broken lines). FIG. 9C shows PDRs from varying-P pSLAM (Eq. 3) at PMT gain 2×104 corresponding to 10 mM NADH/3 PF, 10 mM FAD/2 PF, and coverslip/THG (colored points and arrowed line) along with prediction from Eq. 1 (broken line); right panel shows their counterparts of photon transfer curves (PTCs). FIG. 9D shows PDRs from varying-C (NADH) constant-P (15 mW for regular PMT, 30 mW for hybrid PMT) traditional multiphoton microscopy (Eq. 2) corresponding to a regular PMT (H7422P-40, Hamamatsu) at gain 1.1×106 and a hybrid PMT (R10467U-40, Hamamatsu) at gain 1.2×105 (colored points and arrowed lines) along with prediction from Eq. 1 (broken lines).

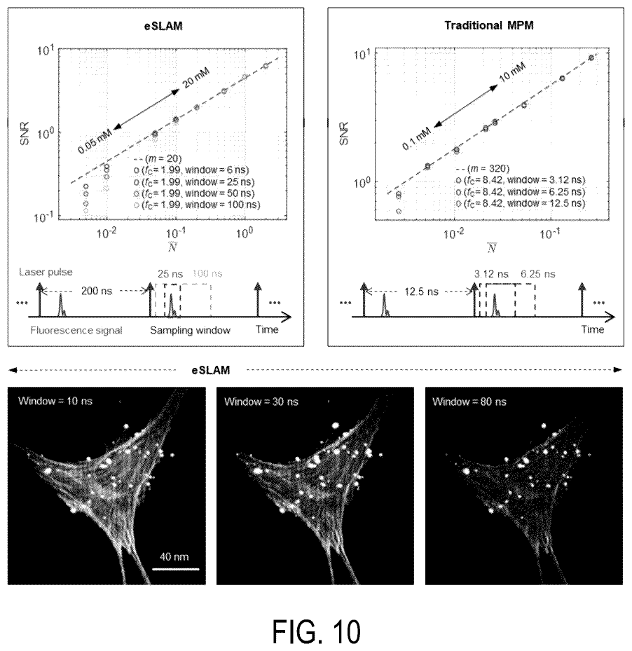

The theoretical log-scale linear relation was valid despite the differences in microscope, n (2 or 3), m (1-320), variable/parameter (C/ƒC or Pⁿ/ƒP), fluorophore (NADH or FAD), photodetector (regular or hybrid PMT), and the temporal window of signal collection optimized for the largest PDR (FIG. 10). In particular, FIG. 10 shows the temporal window targeted to obtain the largest Poisson-noise-dominated dynamic range (PDR) without loss of signal. At top, the dependence of low limit of PDR on temporal window in eSLAM with 200-ns pulse separation (upper left) and a traditional multiphoton microscope MPM with 12.5-ns pulse separation (upper right) are shown; at bottom, the related effect on eSLAM (2 PF) imaging of fixed fluorescent cells (ThermoFisher) showing the ability of optimized temporal window to detect weak signal is illustrated. Without detecting any effect from somewhat variable imaging depth (FIG. 1), the same effective photons from a given C were obtained at two PMT gains that produced 10-fold different arbitrary intensity values (FIG. 9A, arrowheads). Thus, for fixed components and settings, the information of C was encoded by the effective photons from an absolute measurement, not the gain-dependent arbitrary intensity values.

These results suggest that Poisson noise-limited performance may be ensured over time by obtaining the same upper limit of a PDR at a certain gain (FIG. 9A, FIG. 9C) and the same lower limit of the PDR at a high gain (FIG. 9B, FIG. 9D). The PDR with variable P (FIG. 9C, left) is often understood through the shot-noise-limited photon transfer curve (PTC) (FIG. 9C, right), which has assessed PMTs using a LED source and cameras using a uniform lump/LED illumination. This offers an opportunity to evaluate the photon-number-resolving ability of a PMT. By THG imaging of a coverslip interface (homogeneous sample) in a manner like the high-zoom 2 PF/3 PF imaging of a fluorophore solution (FIG. 1), >28 simultaneously arriving THG photons were resolved within a PDR upper limit of 28 effective photons (FIG. 9C), even though the excess noise exceeded 0.5 photoelectron in the continuous histograms of PMT output (FIG. 9A, Inserts). Alternatively (and at a higher cost), discrete photon-number resolving ability has been demonstrated in a point-like superconducting transition-edge sensor and a quanta image sensor by lowering the readout noise of photo-detection below 0.5 photoelectron.

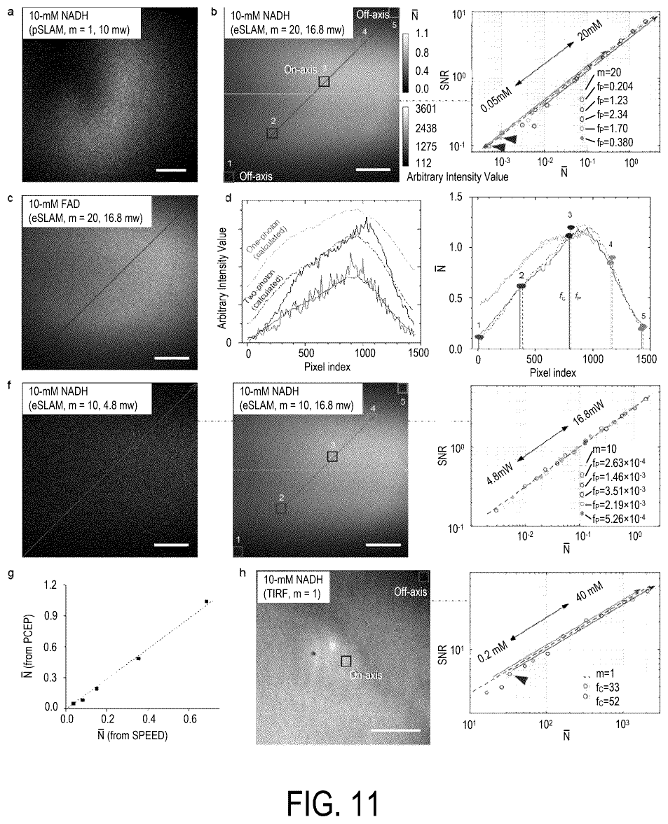

Using the same eSLAM or pSLAM microscope, the above in situ absolute measurement was switched to the visualization of illumination field in fluorophore solutions by simply switching the high-zoom scanning of <10×10 μm² to a low-zoom imaging across ˜250×250 μm² with a frame size of 1024×1024 pixels (FIG. 1) This is illustrated in FIG. 11A, showing a pSLAM illumination field (3 PF) in NADH solution; FIG. 11B, showing an eSLAM illumination field (3 PF) visualized in NADH solution with predefined lines and super-pixels (boxes)—note that the right panel shows PDRs from varying-C (NADH) constant-P experiment (Eq. 2) at PMT gain 4.8×105 corresponding to different super-pixels (colored points and arrowed lines) and prediction from Eq. 1 (broken line). FIG. 11C shows an eSLAM illumination field (2 PF) visualized in FAD solution. FIG. 11D shows diagonal line profiles in FIG. 11B, FIG. 11C, FIG. 11F-left (solid lines) and calculated 1- or 2-photon counterpart of 3 PF/NADH profile in FIG. 11B (broken lines). FIG. 11E shows diagonal/lateral line profiles in FIG. 11B-left and FIG. 11F-middle consistent with properly scaled ƒC/ƒP parameters (vertical segments). FIG. 11F shows an eSLAM illumination field visualized in NADH solution using low P (left) or high P (middle); right panel shows SNR vs. N̅ relation from varying-P experiment (Eq. 3) at PMT gain 4.8×105 corresponding to different super pixels (colored points) and prediction from Eq. 1 (broken line). FIG. 11G shows a comparison of effective photons in a vary-C NADH experiment obtained from either PCEP or single/multi-photon peak event detection (SPEED). FIG. 11H shows a TIRF illumination field (one-photon fluorescence) visualized in NADH solution at 405-nm excitation with on-axis and off-axis super-pixels; right panel shows PDRs from varying-C (NADH) constant-P experiment (Eq. 2) corresponding to the two super-pixels (colored points and solid lines) and prediction from Eq. 1 (broken line). Scale bars in FIG. 11 correspond to 50 μm.

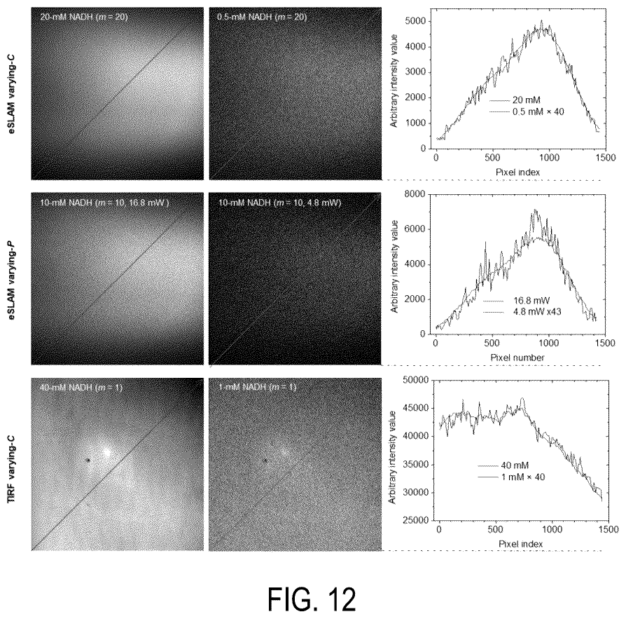

The NADH solutions showed microscope-dependent but C-independent illumination fields pixelated with offset-removed arbitrary intensity values, indicating the off-axis effects such as higher-order field curvature (FIG. 11A, FIG. 11B) as opposed to on-axis illumination (FIG. 1, bottom left). Within the same microscope (eSLAM), comparative results using NADH and FAD solutions also revealed the dependence of illumination field on n and modality/color/channel (FIG. 11B, FIG. 11C). Varying-P (varying-C) experiments using NADH solution(s) revealed no dependence of the illumination field on P or signal strength (C and imaging depth variation), indicating the reliability to visualize the illumination field in a bulk solution (FIG. 12). In particular, FIG. 12 shows visualized illumination field of eSLAM (top, middle) or TIRF (bottom) in a bulk solution independent of NADH concentration (top, bottom) and illumination power (middle). In some examples, the microscopes had made use of the flattening of observed illumination field to optimize the alignment of relaying optics between laser source and photo-detection module.

The optimized 3 PF/NADH field remained rather uneven due to high photon-order illumination, even though its predicted linear (one-photon) field was acceptably flat (FIG. 11D). This unevenness might have affected the reported FOV (123×123 μm²) of deep 3 PF imaging. Also, the comparison between the observed 2 PF/FAD field with the predicted two-photon field of the observed 3 PF/NADH field highlighted the noticeable dependence of the field illumination (FIG. 11D, blue curves) on modality-specific detection path and efficiency (FIG. 1). This complexity from multi-color detection, along with the non-absolute measurement of the illumination fields (with sample-dependent PMT gains and other device settings of digitizer, amplifier, and/or attenuator), have complicated the isolated quantity control of flat-field illumination using fluorescent slides and bulk solutions.

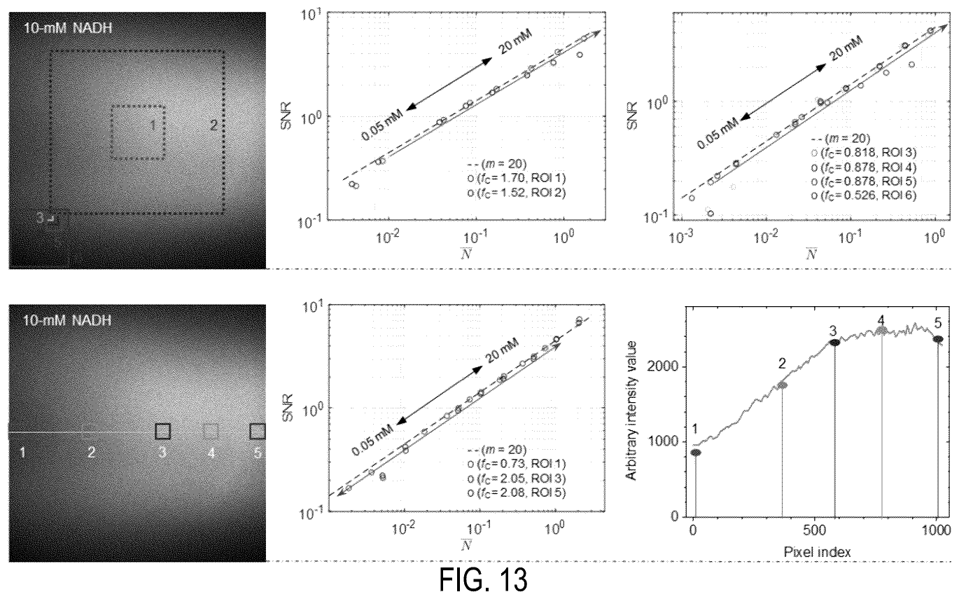

Three quality-control subtasks for reproducible and quantitative light microscopy are Poisson noise-limited detection, stable illumination, and flat-field illumination, which to date have been treated as independent goals (Table 1). After performing the three subtasks in two procedures detailed above, they were integrated into one simple, single procedure. Some previous attempts at such integration employed inhomogeneous samples and thus disengaged the flat-field illumination. To engage this subtask, the pixelated arbitrary intensity values from the varying-C calibration (FIG. 11B) were quantitatively analyzed, which revealed the dependence of PDR on the size and location of region-of-interest (ROI) inside the FOV (FIG. 13). FIG. 13 shows detailed PCEP calibration at P=16.8 mW. The top row shows the dependence of observed Poisson-noise-dominated dynamic range (PDR) on the size and location of region-of-interest (ROI) inside the illumination field. The bottom row shows convergent PDRs of different super-pixels with ƒC parameters proportional to local illumination field strengths (right panel).

A preferred size of 30 pixel×30 pixel or 7.5 μm×7.5 μm, termed as a super-pixel, was used. This so-called super-pixel size was small enough to ensure a uniform ROI (required for Eqn. (1)) but large enough to generate a statistically convergent PDR across the FOV (FIG. 11B, right; FIG. 13). Because the fc parameters associated with different super-pixels scale with locally averaged illumination field strengths, the information of one constant C is encoded as different effective photons for individual pixels (FIG. 11B vs. FIG. 11D vs. FIG. 11E) after converting the arbitrary intensity values to effective photons (FIGS. 6 and 8, middle panels). In other words, the same effective photons at different pixels can represent different local C in a bio-specimen, depending on their locations in the uneven illumination field. Thus, this integration process may be referred to as “pixelating with concentration-encoded effective photons” (PCEP), which departs greatly from previous in situ measurements of homogeneous samples.

Unexpectedly, the lower limit of the PDR associated with an on-axis super-pixel (˜0.01 effective photon), i.e., detection limit due to the onset of specific non-Poisson noise that cannot be lowered by an increased m (FIG. 9B), can be lowered by an increased off-axis extent down to ˜0.001 effective photon (FIG. 11B, arrowheads). This effect suggests that the non-Poisson noise originates from local illumination field (which is worth future more detailed studies) rather than a constant additive noise dictated by electronic settings such as the temporal window. The PCEP technique described in the present disclosure produced an upper limit of ˜0.001 effective photon for the additive noise. The low illumination field strength (i.e., low signal) of off-axis super-pixels in comparison to on-axis super-pixels is countered by an enhanced photo-detection (absence of non-Poisson noise) to homogenize the detection dynamic range in C (˜0.1-20 mM NADH) across all super-pixels (FIG. 11B, right). The resulting detection limit of ˜0.1 mM NADH is termed as non-Poisson noise-equivalent concentration (NPNEC).

Thus, a misalignment-induced off-axis field illumination may produce a seemingly low detection limit in effective photons by the in-situ measurement of analog photo-detection, which would be mistakenly attributed to a high detection performance. This observation emphasizes the advantage of integrating the three subtasks by PCEP. Also, the observed off-axis-enhanced photo-detection is especially beneficial for quantitative imaging of weak signals, using a strategy that rapidly acquires and averages single low SNR frames with either low-P illumination or low-C fluorescence labeling. This strategy mitigates the need to shrink the FOV despite the highly uneven 3 PF field illumination (FIG. 11D). A similar strategy has been appreciated for reduced phototoxicity, but not for quantitative imaging.

From the perspective of routine quality control, a varying-P calibration (FIG. 9C) is simpler than the varying-C calibration to perform PCEP, because it retains the absolute measurement of the latter using one constant C. After a varying-C calibration in eSLAM (FIG. 11B) and 2 months of frequent biological imaging, one varying-P calibration that confirmed its equivalence to the varying-C calibration (FIG. 11F) was conducted, except for the absence of lower detection limit that required a more accurate power-meter. The ƒP parameters associated with various super-pixels scaled with the corresponding ƒC parameters, while the continuous illumination field in effective photons approximated its varying-C counterpart (FIG. 11E). It is thus feasible to ensure reproducible 3 PF/NADH imaging via the varying-P calibration at different time points by first obtaining the same illumination field pixelated with effective photons and then the upper limit of additive noise from the weakest super-pixel. The former ensures no drift in optical alignment while the latter is necessary to monitor the aging of a point-like photodetector without interference from field illumination.

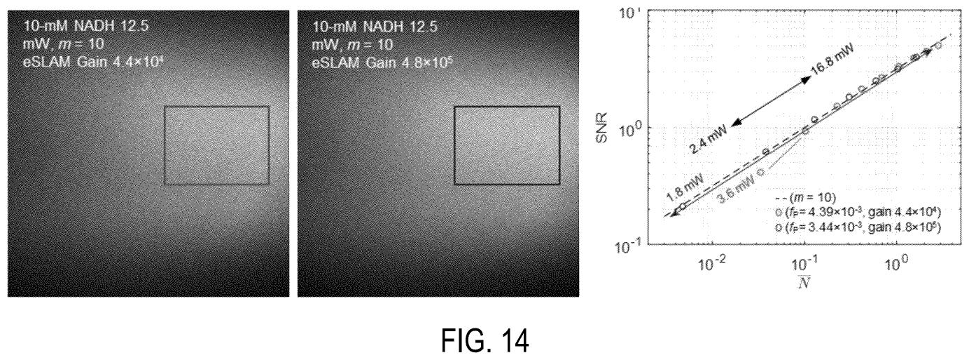

To extend the single-color PCEP of 3 PF/NADH to the multi-color/modality detection of eSLAM with different PMTs (Table 3), additional varying-P calibrations were performed for 2 PF/FAD, SHG, and THG imaging (FIG. 6). As described above, a photon crosstalk matrix can be established to quantify the color bleed-through among 4 modalities regardless of PMT gain and other detection settings (FIG. 1). The flexibility in PMT gain allows tunable detection sensitivity and dynamic range (FIG. 14, showing decreased detection sensitivity and PDR at a lower PMT gain in the eSLAM varying-P experiment of FIG. 3F) for different biological samples or applications, but may prevent an arbitrary intensity analogue of this crosstalk matrix for objective quantification. In fact, the photon crosstalk matrix can be used to guide selections of excitation bands, dichroic mirrors, and optical filters (FIG. 1) in a feed-back process to minimize signal crosstalk while retaining detection efficiency.

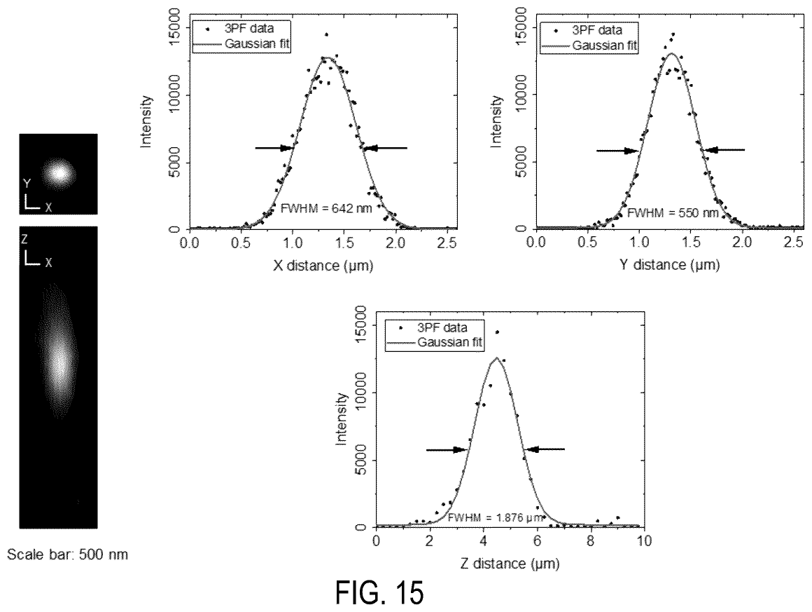

FIG. 15 shows a measurement of point spread function of eSLAM via a fluorescent bead. Fluorescent beads of 100 nm diameter (Fluorophorex polystyrene nanospheres, No. 2002 with EM/EX 345/435 nm Phosphorex, Inc) were embedded in an agarose solution and used for the PSF measurements of three-photon fluorescence imaging. The resulting 3D images were collected over a FOV of 20 μm×20 μm with 0.25 μm axial step and 10 μm total depth. The point spread function (PSF) of eSLAM was measured using ˜100-nm fluorescent beads and confirmed near diffraction-limited lateral-axial resolution. Because any degradation of PSF will weaken the effective photon-pixelated illumination field, this PSF measurement can be used as a dependent subtask that only requires one-time quality control effort, which can be guaranteed if no change is detected from routine PCEP calibrations. Thus, an automatic 3D microscope stage with repeatable positioning (used for the PSF measurement) can be used as an optional quality-control subtask, as it is neither needed in PCEP (using a manual 1D stage) nor in some applications free of multi-FOV stitching (e.g., cell culture-based drug testing and clinical imaging). In this way, 6 major quality-control subtasks can be reduced to one routine procedure (FIG. 2) especially beneficial for portable imaging.

To test the benchmarking by PCEP, the C-encoded effective photons from PCEP were compared with those from time-tagged computational photon-counting9 in the experiment of FIG. 9B. The two independent methods yielded consistent results except for a proportional factor of 1.46 (FIG. 11G). Overall, eSLAM attained an upgrade over SLAM to perform fluorescence lifetime imaging microscopy (FLIM) (FIG. 5). Using safe illumination powers that empirically avoided the phototoxicity of elevated auto-fluorescence, the performance of SLAM-based microscopes were compared to conventional multiphoton microscopes in optical metabolic imaging of NADH and FAD. An advantage of eSLAM to achieve a higher NADH imaging sensitivity by 3 PF over 2 PF was observed (Table 3). It is this pixelwise ability to encode C that as one example separates the PCEP techniques described in the present disclosure from a reported performance comparison among optical sectioning microscopes, which also converted the arbitrary intensity values of point- and camera-like detectors to effective photons. To test the applicability of PCEP to camera-like detectors, the varying-C NADH calibration was performed on EMCCD camera of a total internal reflection fluorescence (TIRF) microscope (FIG. 12). The validity of PCEP was confirmed with an NPNEC of ˜0.5 mM under the assumed safe illumination (FIG. 11H, arrowhead).

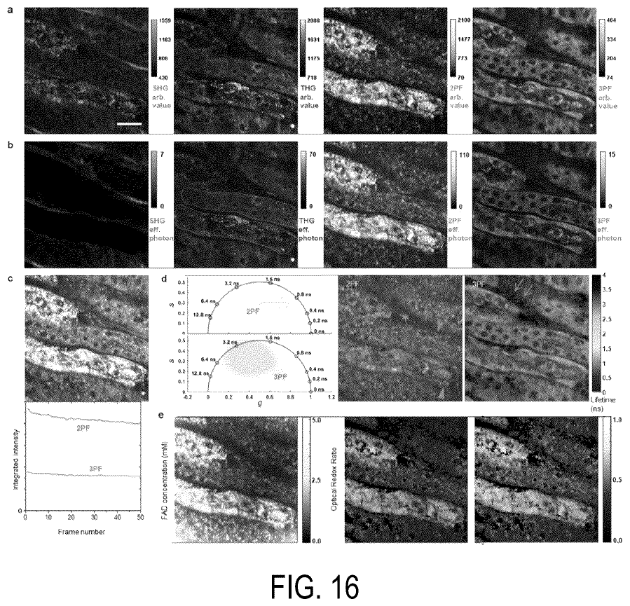

FIG. 16 shows quantitative biological imaging by eSLAM. The scale bar represents 50 μm. FIG. 16A shows arbitrary intensity value-pixelated images of ex vivo rabbit kidney at ˜15-μm imaging depth with SHG, THG, 2 PF/FAD, and 3 PF/NADH signals (50-frame summation). FIG. 16B shows corresponding effective photon-pixelated images after color bleed-through correction showing kidney epithelial cells with average effective photons per pixel of 27 (THG), 30 (FAD), and 3 (NADH). FIG. 16C shows composite image (top) and real-time monitoring of FAD/NADH photo-bleaching during time-lapse imaging (bottom). FIG. 16D shows phase plots (left) and corresponding FLIM images of FAD and NADH (right) showing fluorescence lifetime with intensity overlay (9-pixel averaging over neighboring pixels). FIG. 16E shows an image of FAD concentration corrected for uneven field illumination (left) and related images of optical redox ratio with (middle) and without the field correction (right).

To demonstrate the quantification by PCEP, eSLAM imaging was conducted on unlabeled cells and extracellular components of an ex vivo rabbit kidney (FIG. 16A). By performing arbitrary-intensity-value-to-effective-photon conversion established by PCEP and ignoring the difference of modality-dependent illumination fields (FIG. 11D, blue curves) as a first approximation, the calibrated photon crosstalk matrix (FIG. 1) was employed to correct across-modality color bleed-though and quantified the kidney cells across the modalities of 2 PF/FAD, 3 PF/NADH, and THG (FIG. 16B). The weak SHG signal from basement membrane-like collagen, which would otherwise be obscured by a strong 2 PF bleed-through, became clearly discernible (compare FIG. 16A and FIG. 16B, green contrast). Gradual photo-bleaching occurred in 2 PF and 3 PF (full FOV) without the phototoxicity of elevated auto-fluorescence during time-lapse imaging (FIG. 16C). The frame acquisition time (˜0.33 s) of eSLAM using a resonant-galvanometer scanner allowed real-time monitoring of photo-bleaching and phototoxicity, in contrast to SLAM with a slow galvanometer-galvanometer scanner.

Corresponding FLIM images and phasor plots for 2 PF/FAD and 3 PF/NADH signals were produced (FIG. 16D). Interestingly, two different kidney tubules distinguishable by 2 PF intensity and lifetime can be attributed to the proximal and distal tubules with presumably different cellular metabolism (FIG. 16B, 16D, arrowheads). The FLIM data not only distinguishes the two tubules better than 2 PF intensity (FIG. 16D, star), but also uniquely identifies the hemoglobin Soret fluorescence (peaked at 438 nm) from blood cells by its ultrashort lifetime (FIG. 16D, arrows). Local absolute concentrations of FAD (or NADH) can be derived from the pixelated C-encoded effective photons via the phasor plots and corrected for the uneven 2 PF/3 PF field (FIG. 16E, left). The corresponding image of optical redox ratio CFAD/(CNADH+CFAD) is thus obtained with rather small dependence on the field correction (FIG. 16E, right panels). Further refinement of this metabolic imaging can be used to discriminate NADH against NADPH (or FAD against cellular lipofuscin) in the 3 PF (or 2 PF) modality.

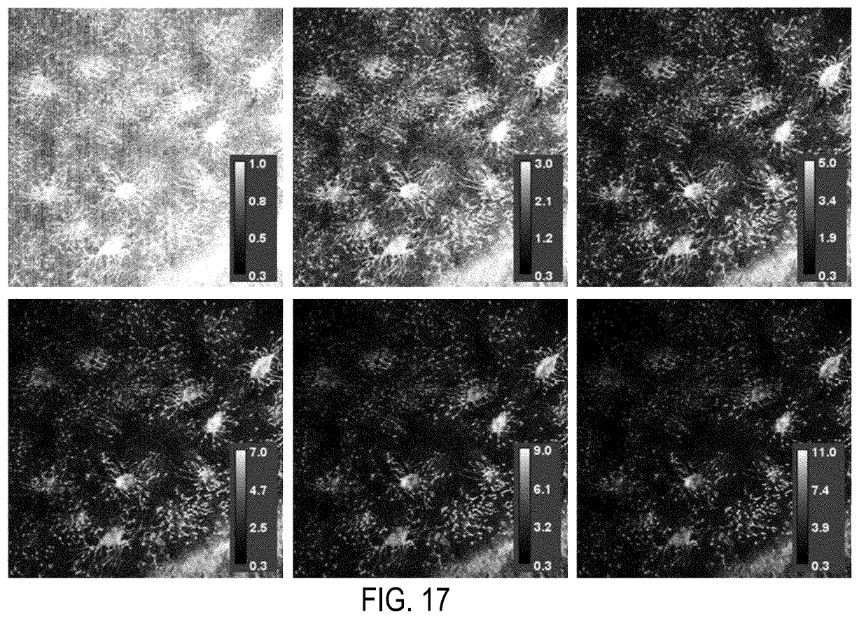

To reveal the enabling role of PCEP in microscopy-biology interaction, eSLAM was tested in numerous cell/tissue specimens and validated the safe illumination power (Table 3) while confirmed no saturation (FIG. 9A, Insets) under a moderate PMT gain. The largest biological signal was obtained from mouse skull (THG up to 11 effective photons per pulse), which would saturate the photon-counting in SLAM under the same excitation (FIG. 17). FIG. 17 shows single-frame THG images of osteocytes in ex vivo mouse skull from gentle eSLAM imaging (13 mW on sample). The high dynamic range of the images is displayed with different scales in effective photons while the statured image (upper left) associated with scale (0-1) is expected from the photon-counting detection of SLAM. Also, the generally low cellular NADH signal in comparison to cellular FAD signal favors 1110 nm (eSLAM) over 1030 nm (pSLAM) for excitation (Table 3). This performance benching suggests there may be an advantage to building a portable eSLAM microscope. Moreover, the observed dependence of illumination field on free-space detection path/modality (FIG. 11D, blue curves) points to an attractive alternative of optical fiber-coupled 16-channel spectral detection module free of this dependence (FIG. 1, upper right), which would also permit tunable excitation. In this prototypical process to optimize nonlinear optical imaging, PCEP allowed a custom-built microscope to co-evolve with the biology of interest toward reproducible, quantitative, gentle, and portable imaging.

### Discussion

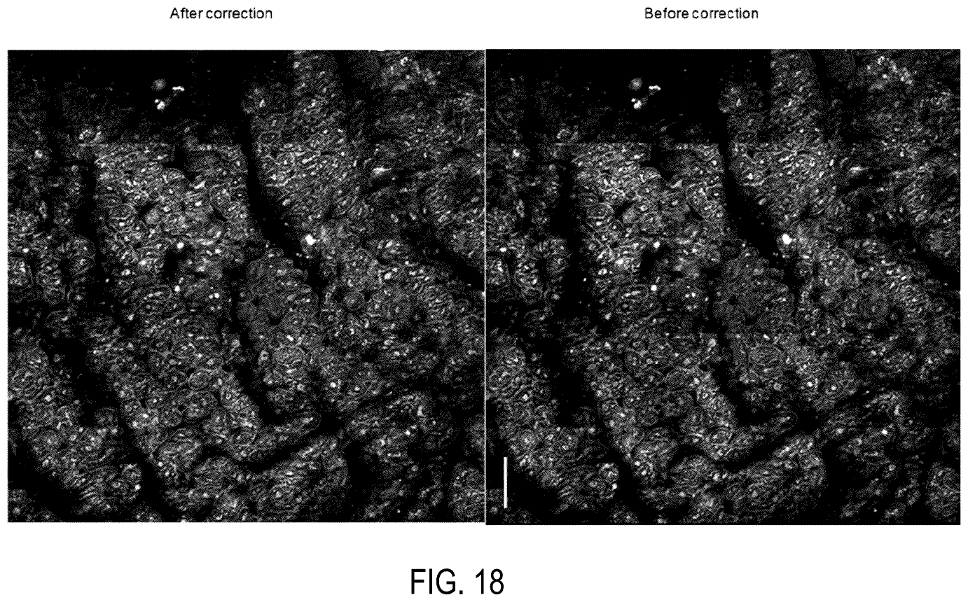

The quality-control tool of PCEP is generally applicable to molecular optical sectioning microscopy with a well-defined planar illumination field. With PCEP, image processing can be limited to rather simple tasks such as shading correction (FIG. 18), without any deconvolution or reconstruction that may prevent real-time visualization and/or quantitative analysis. Advantageously, the underlining mechanism of PCEP can be broadly applicable to confocal microscopy and light-sheet microscopy, in addition to the laser-scanning multiphoton microscopy and wide-field TIRF microscopy techniques described in the present disclosure. This is timely due to the recent standardization of laser-scanning confocal microscopy. PCEP can be implemented using only a bulk fluorophore solution as standard sample, and thus avoids the special preparation of thin (˜200 nm) and flat uniform fluorescent samples. After placing the illumination field inside the solution just like how biological imaging is done, the varying-P PCEP calibration becomes a simple procedure widely supported by commercial microscopes. The procedure may be automated for routine self-diagnostic quality control of a core (static) imaging facility. This automation will be particularly beneficial for a portable imaging facility because the embedded absolute measurement allows sensitive detection of any changes to laser source, photo-detection module, and relaying microscope optics. FIG. 18 shows shading correction of effective photon-pixelated 5×5 mosaic-stitched 3 PF image from ex vivo rabbit heart tissue. While a large overlapping ratio for adjacent field-of-views (˜30%) limits shading effect (top), residual artifacts (arrowheads) can be largely corrected by the known 3 PF field from an NADH solution (bottom). The scale bar represents 100 μm.

Routine PCEP calibrations enable image pixel representation by the effective photons within a measured PDR (rather than an arbitrary intensity value). The error at each pixel is thus the squared root of the effective photons. This not only enables objective assessment of image quality but also supports a standard image format (Table 1). Storing images in a standardized format permits quantitative comparison of images from not only the same microscope over time, but also diverse microscopes with rich sample types, molecular targets, and imaging contrasts (e.g. fluorescence, harmonics, and molecular vibration), allowing buildup of image archives for large-scale reanalysis. Also, PCEP may empower photon-counting detection to measure PDR and encode C, so that a specific imaging experiment can be reproduced by obtaining the same effective photon-pixelated image regardless of photo-detection mode. The resulting C-encoded effective photons may be correlated with the local concentration of an intrinsic or fluorescence-labeled biomolecule of interest. Beyond single-color imaging, proper PCEP calibration can quantitatively correct the color bleed-through in multicolor imaging of multiple biomolecules. Additionally, by taking account of phototoxicity, PCEP can benchmark the performance of different modalities or microscopes to image the same molecular targets.

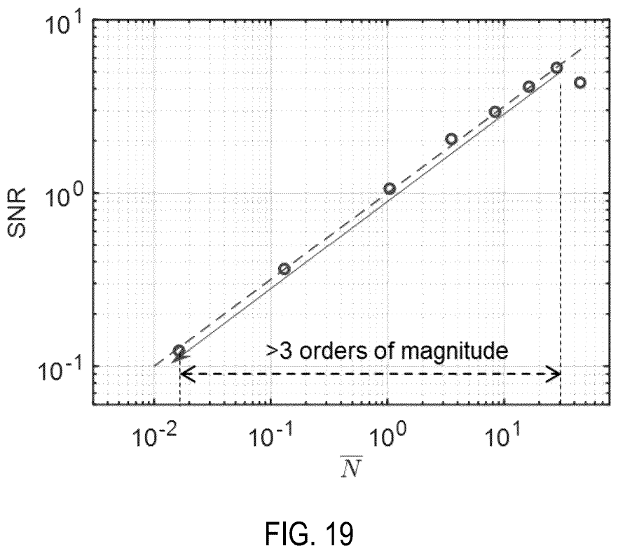

Beyond the quality control of a preexisting microscope, PCEP can serve as a precision measurement tool to optimize a custom-built microscope, with a detection limit down to 0.001 effective photon and a dynamic range of more than 3 orders of magnitude for a typical PMT at one gain. FIG. 19 shows high dynamic range PDR with >3 orders of magnitudes in effective photons in the experiment of FIG. 9C (THG in pSLAM). PCEP-assisted upgrade of SLAM (photon-counting) to eSLAM (analog photo-detection) transforms a low signal rate of less than one effective photon per pulse to a high signal rate of up to 11 simultaneously arrived effective photons per pulse under safe biological illumination. The idealized design of eSLAM may serve as the starting point to generalize PCEP to diverse designs of molecular optical sectioning microscopy. In this process, PCEP may play a similar enabling role to optimize relevant elements of microscopy (choice of imaging modality, illumination P/field/photon-order, photo-detection mode/gain/color, microscope objective, zoom or FOV, pixels per frame, frame acquisition time, etc.), by linking them with interacting biological elements (fluorophore C, photo-bleaching, targeted or labeled biomolecules, samples of interest, intended spatial/temporal resolution, phototoxicity, etc.).

At large imaging depths, PCEP-calibrated quantification becomes susceptible to the interference of out-of-focus background in deep imaging, which depends on sample absorption-scattering properties and thus requires specific protocol to estimate. One way to navigate this challenge is to work with thin sectioned samples and thin homogeneous fluorescent phantoms, so that PCEP-based quality control may be extended to the wide-field epi-fluorescence microscopy with non-laser light sources.

### Example 2

In another example study, the PCEP techniques described in the present disclosure were evaluated using cell cultures and/or bulk solution preparations.

### Methods

The fast 4-channel SLAM platform and system shown in FIG. 3 was used also for this example study, which was designed to simultaneously acquire FAD signal from 2-photon channel, NAD (P) H signal from 3-photon channel, combined with non-centrosymmetric structures from the SHG channel and interfacial features from the THG channel. By using a 40 μm large-core photonic crystal fiber (PCF, type), the high peak-power pulses of 1030±4 nm with an average power of 3.25 W were first broadened to generate a supercontinuum at a repetition rate of 5 MHz. This supercontinuum was then sent into a 128-pixel 4-f pulse shaper (femtoJock Box, BioPhotonic Solutions Inc.) to enable the selection of a shifted excitation window of 1110±30 nm and output the beam on sample near-transform-limited through dispersion compensation. The 1110±30 nm pulses from pulse shaper were raster scanned by a resonant mirror (10×10 mm, 1592.33 Hz, EOCP) and a galvo mirror (GVS011, Thorlabs) and focused by an inverted objective (UAPON 40XW340, N.A.=1.15, Olympus) with up to ˜30 mW average power on the sample. The actual/safe power on the sample can be adjusted by a neutral density (ND) filter. Two achromatic doublets (AC254-030-C-ML-f=30 mm, AC508-100-C-ML-f=100 mm, Thorlabs) were used to expand the beam to fill the back focal plane pupil of the objective (Ø10.35 mm). Due to the generation of high photon rate by using high peak power, the excited autofluorescence signals were detected using analog PMTs (PMT H7422A-40, Hamamatsu for 3PAF and 2PAF channels; PMT H10721-20, Hamamatsu for SHG channel, PMT H10721-210, Hamamatsu for THG channel) instead of photon-counting PMTs and spectrally-separated into 4 detection channels by long-pass dichroic mirrors and appropriate band-pass filters (FIG. 3). The selection of channels is based on the principle of minimizing the crosstalk and maximizing the detection efficiency.

For this 5 MHz SLAM system, the 2-photon and 3-photon channels are designed with both multiphoton and fluorescence lifetime acquisition capabilities. The signals of these two channels are respectively sent to a high-speed current-to-voltage conversion amplifier unit (C5594-12, Hamamatsu) with 1.5 GHz cutoff frequency, which can accurately and reliably amplify the PMT pulse output. The converted voltage signals were then digitized by a 2 GS/s dual-channel high-speed digitizer (ATS9373, AlazarTech). The signals from SHG and THG channels were respectively amplified by a 60 MHz bandwidth amplifier (TIA60, Thorlabs) and digitized by a 125 MS/s digitizer (ATS9440, AlazarTech). A GPU (GeForce RTX 2080, NVIDIA) was used to enable and accelerate the real-time display of acquired data and the compression of massive raw data for saving by time-gated window. To ensure that there is no data overflow for time-lapse acquisitions (>1000 frames), the system frame rate was set to ˜0.56 Hz when saving both processed images and compressed raw data of 4 channels, and it can reach ˜0.8 Hz unidirectional scan frame rate (˜1.7 Hz for bidirectional scan) while only saving processed images. Meanwhile, to keep the change in image pixel size on the fast axis as small as possible while using the resonant mirror with 1592.33 Hz, the active acquisition length of a line was designed to occupy 65% of the total length of the line (spatial fill fraction) for image with 1024×1024 pixels, and there was only one pulse on each pixel per frame, and pixel dwell time was 0.2 μs. A custom control software based on LabVIEW was used to meet diverse imaging acquisition needs.

An adherent Syrian golden hamster (Mesocricetus auratus) kidney fibroblast cells (BHK-21, clone 13, ATCC #CCL-10) were cultured in disposable BioLite™ 75 cm2 vented-cap cell culture treated flasks in phenol red-free Gibco™ Dulbecco's Modification of Eagle's Medium (DMEM) (ThermoFisher Scientific (TFS), #21063029) containing 25 mM HEPES, 4 mM L-Glutamine, 25 mM D-glucose (dextrose) and supplemented with 5% heat-inactivated HyClone™ Characterized Fetal Bovine Serum (FBS) (Cytiva, #SH30071.03) as well as 1% Gibco™ Antibiotic-Antimycotic (penicillin/streptomycin/amphotericin B) solution (TFS, #15240062). Cells were maintained inside a humidified incubator with 5% CO2 and 21% O2 conditions at 37° C. Cells were routinely sub-cultured by trypsinization using phenol red-free 0.25% Trypsin-EDTA solution, with an incubation time of 3 min, and trypsin neutralization by adding 10% FBS-containing DMEM. A 0.5-1 ml volume of harvested cells was resuspended in 1.5-1 ml of phenol red-free Gibco™ 1X TrypLE™ Select Enzyme (pH 7.0-7.4) cell dissociation reagent (TFS, Cat #12563029) in triplicates. The total and viable cell numbers, cell diameter, and viability (%) were estimated by using a Beckman Coulter Vi-CELL XR Automated Cell Viability Analyzer under default mammalian cell type settings.

NADH (Grade I, Sigma) and FAD (94% dry wt., ThermoFisher Scientific) were dissolved in a 1 M HEPES buffer to maintain a stable pH. Rhodamine B and acridine orange were dissolved in sterile water, Fluorescein was dissolved in 100% ethanol, and Staurosporine (STS) was dissolved in Phosphate buffered saline (PBS).

### Principle of Photon Counting Using Binomial Fitting

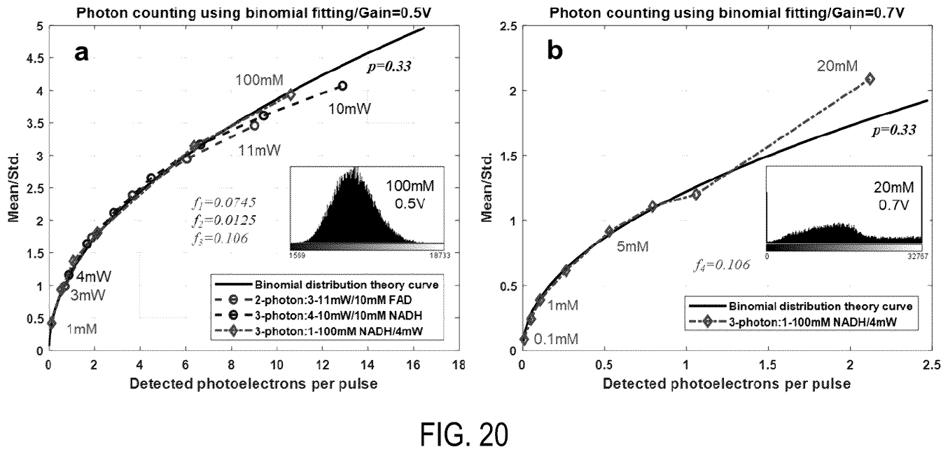

FIG. 20 shows photon counting using binomial fitting on a 0.83 MHz imaging system. In FIG. 20A, the black line is a theoretical curve of photoelectron number per pulse and mean/std. using PMT2101 (Thorlabs) with 0.5V control voltage at 447 nm (same p value at 618 nm); The red line fitting is a power-dependent experiment of 2-photon excitation of 10 mM FAD solution with 0.5 V control voltage (power: 3/5/7/9/11 mW); the blue line fitting is a power-dependent experiment of 3-photon excitation of 10 mM NADH solution with 0.5 V control voltage (power on sample: 4/5/6/7/8/9/10 mW); The purple line fitting is a concentration-dependent experiment of 3-photon excitation of NADH solution with 0.5 V control voltage and 4 mW on sample (concentration: 1/5/10/20/60/100 mM), and the histogram of 100 mM NADH imaging is shown in the inset. In FIG. 20B, a concentration-dependent experiment of 3-photon excitation of NADH solution with 0.7 V control voltage and 4 mW on sample (concentration: 0.1/0.5/1/2.5/5/7.5/10/20 mM) is shown, and the histogram of 20 mM NADH imaging is shown in the inset (the pixel saturation gray value is 32767). Note: PMT2101 was used in all four experiments.

According to probability theory, for an analog PMT, both the conversion of photons into photoelectrons and the collection of photoelectrons are independent events, so the binomial distribution model can be used to describe the distribution of detected photoelectrons:

$$f ( x \vert N , p ) = {C}_{N}^{x} {{p}^{x} ( 1 - p )}^{N - x} \\ for x = 0 , 1 , 2 , … , N \qquad ( 4 )$$

where x is the detected photoelectrons per pulse, N is the photon number per pulse before reaching the PMT, p is the probability of converting photons into photoelectrons, and p is the product of quantum efficiency (QE) and collection efficiency (CE). The result is the probability of exactly x successes in N trials. Moreover, for the binomial distribution model, when p is fixed, the ratio of the mean to the standard deviation Mean/Std increases with the photon number N (black curve in FIG. 20). For a particular PMT, the ratio is related to the number of photons by:

$$Mean / Std . = \frac{\sqrt{m} N}{\sqrt{N p ( 1 - p )}} \qquad ( 5 )$$

where m is the pulse numbers per pixel. For analog PMTs, the key to photon counting is how to correlate the analog output signal with the photoelectron count. Among them, the analog output can be expressed by the gray value of the image pixel, and the generated photoelectrons are related to parameters such as incident light or sample characteristics. Because the nonlinear optical signal scales with Eⁿ (E is the average power on sample and n is the order of nonlinear process), the relationship between photoelectrons and the power on the sample E can be described as, photoelectrons=ƒ×Eⁿ, where f is a fitting factor and the only variable. Therefore, based on the power-dependent experiments of homogeneous solutions, by fitting the experimental data and theoretical curve (black curve in FIG. 10), the correlation between the pixel gray value of the image and the detected photoelectrons can be realized. Similarly, photon counts can also be achieved by fitting through solution concentration-dependent experiments, and determine photoelectrons=ƒ×concentration. The photon number before reaching the PMT can be therefore represented by photons =photoelectrons/p. By using this method, the relationship between the gray value of pixel and the number of photoelectrons can be calibrated with only one power/concentration-dependent experiment and used in subsequent experiments. Moreover, photoelectron counting can be realized from the detection limit to the saturation of the PMT.

To verify this photon counting method, both power-dependent experiments and concentration-dependent experiments of 3-photon excitation of NADH solution were performed (FIG. 20A) on a 0.83 MHz imaging system with single pulse per pixel label-free imaging capability. Meanwhile, power-dependent experiments of 2-photon excitation of FAD solution (FIG. 20A) were also conducted to validate the applicability of this method in nonlinear excitation processes of different orders. The results in FIG. 20A showed that the experimental data can fit the theoretical curve well in different situations with high quantifiable dynamic range, which can reach up to mean 10 photoelectrons per pulse for this case with 0.5 V control voltage. Furthermore, concentration-dependent experiments of 3-photon excitation of NADH solution with 0.7 V control voltage (FIG. 20B) were also conducted to validate the consistency of the quantitative results compared with the 0.5V control voltage case. The results indicated that the quantified mean photoelectrons per pulse are the same under the same excitation conditions (mean 0.106 and 0.53 photoelectrons for 1 mM and 5 mM NADH, respectively), and the maximum dynamic range dropped to ˜1 photoelectron due to the increased gain of PMT and was also affected by the input voltage settings of digitizer. As shown in the histogram of FIG. 20B, saturated pixels in the image (20 mM NADH, 0.7 V) altered the supposed binomial distribution (histogram of FIG. 20A, 100 mM NADH, 0.5 V) and make the fit deviate from the theoretical curve, which can be used to identify the maximum quantifiable dynamic range. In summary, the above experiments demonstrated that the proposed method can quantify the output digital data from digitizer to a photon number with high dynamic range when the PMT and digitizer are not saturated.

### FLIM Imaging Capability and Photon Counting Correlation

By employing a 40 μm large-core photonic crystal fiber (PCF, type) and supercontinuum technology, high peak power laser pulses (nJ) were achieved at a repetition rate of 5 MHz, which can greatly improve the multiphoton excitation efficiency. At the same time, by using a 1592.33 Hz resonant scanner (PLD-1S, EOPC) and a 2 GS/s dual-channel digitizer (ATS9373, AlazarTech), a fast SLAM microscopy with a repetition rate of 5 MHz is designed for single-pulse per pixel imaging, which not only can reduce the phototoxicity to biological samples but also allows the system to maintain fluorescence-lifetime imaging capabilities.

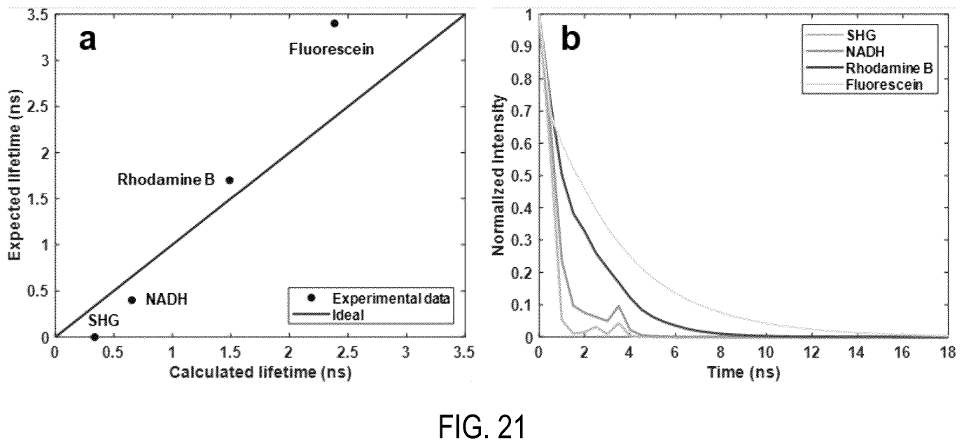

FIG. 21 shows fluorescence lifetime accuracy using various standards. FIG. 21A shows calculated lifetimes and expected values for four different well-characterized fluorophores/harmonophores. Experimental data is represented by the blue dots and the ideal data based on known fluorescence lifetime values is shown by the red line. To verify the performance of this system in fluorescence lifetime imaging, the lifetimes of some typical samples were tested using both SPEED and direct pulse sampling methods, as shown in FIG. 21A. Specifically, FAD, Rhodamine B, Fluorescein and Urea crystal were used to calibrate the 2-photon channel, and NADH was used to calibrate the 3-photon channel. FIG. 21B shows fluorescence decay curves for each calibration fluorophore/harmonophore. For low lifetimes, such as NADH and SHG, a reflection from the amplified is occasionally present a few ns after photon arrival and is high enough in magnitude to register as a photon count.

Since the SPEED method based on raw data can quantify the number of photons, the results of photon counts based on different concentration NADH solution using the binomial fitting method and the SPEED method were compared, and the results showed that the photon counting results of the two methods have a good linear correlation, as shown in FIG. 21. The difference between the two methods is that the SPEED method requires high sampling rate (>1GS/s) to restore the original signal, and therefore has high consumption on acquisition and computation; whereas the photon counting method using binomial fitting does not have these requirements and simply uses the image pixel gray value based on the integrated signal.

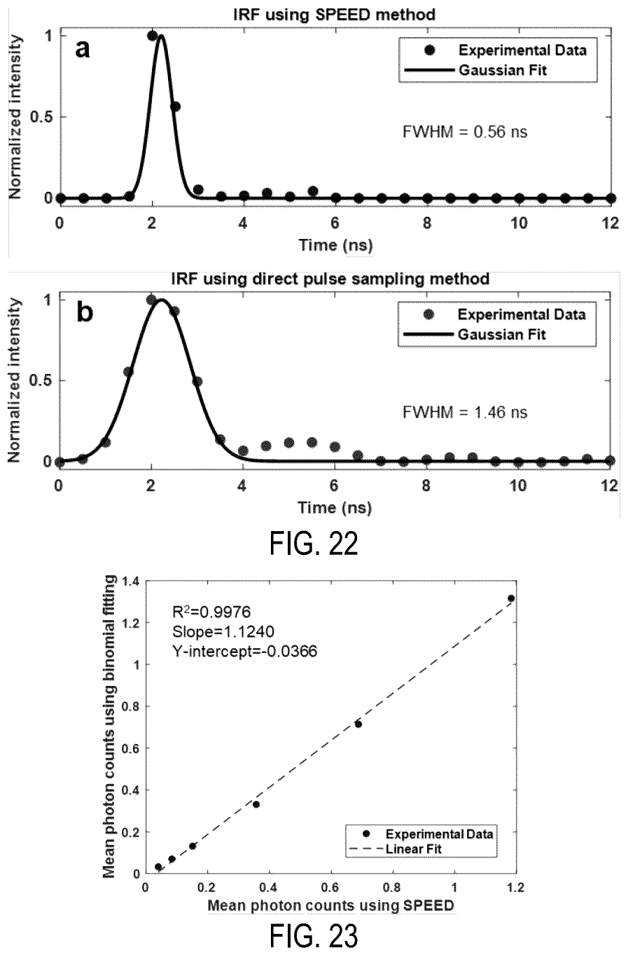

To verify the performance of this 5 MHz system in fluorescence lifetime imaging, the lifetimes of SHG (˜0.0 ns), NADH in 1M HEPES (˜0.4 ns), Rhodamine B in water (˜1.7 ns), and Fluorescein in ethanol (˜3.4 ns) were tested using computational photon counting by employing the single-and multi-photon peak event detection (SPEED) algorithm, as shown in FIG. 21A. Specifically, Rhodamine B and Fluorescein were used to calibrate the 2-photon channel, NADH was used to calibrate the 3-photon channel, and the temporal impulse response function (IRF) of the system was determined by imaging SHG from a urea crystal. FIG. 22 shows impulse response function for fluorescence lifetime capabilities. Impulse response functions based on SHG of urea crystal using (FIG. 22A) SPEED for computational photon counting are shown in blue and (FIG. 22B) for the analog output/direct pulse sampling method in red. Gaussian fits (black lines) were used to estimate the full-width at half-maximum is given for each, which is given in ns. Results showed that the estimated fluorescence lifetimes were similar to the known values, however low fluorescence lifetimes (such as NADH and SHG) were biased slightly higher due to the limited bandwidth of collection electronics, and longer fluorescence lifetimes (Rhodamine B and Fluorescein) were biased to lower values, likely due to the low probability of collecting and properly time-tagging later-arriving photons when using one laser pulse per pixel and inferring the laser pulse synchronization, as is done in computational photon counting.

The IRF of the system (using the H7422-40 PMT, C5594 amplifier, and ATS9373 ADC) had a full-width at half-maximum (FWHM) of 0.56 ns, slightly higher than previously reported IRFs estimated using SPEED which used a different PMT and faster digitization rates (0.32 ns IRF with 3.2 GS/s ADC, 0.23 ns IRF with 5 GS/s ADC). Overall, while the fluorescence lifetime values present some bias compared the expected values, these data show the ability to detect contrast in fluorescence lifetime for a variety of fluorophores and fluorescence lifetime values and prove that this system can be used to examine relative changes in fluorescence lifetime over the range of interest for NAD(P)H and FAD. In some implementations, deconvolution or other transforms can be used to shift experimental fluorescence lifetime values to coincide more closely with expected values.

Both SPEED and binomial fitting methods were used to quantify the average number of photons per pulse using different concentrations of NADH from 0.5 to 20 mM. Data was fit to linear curve to determine the average number of photons per pulse per 1 mM NADH. For SPEED, 0.060 photons/pulse/1 mM NADH was estimated, and for binomial fitting 0.068 photons/pulse/1 mM NADH was estimated. While not exactly the same, both show similar scales of photons counted and show a strong linear correlation. FIG. 23 shows estimated photon counts for 0.5 to 20 mM NADH using binomial fitting and SPEED. Both methods were used to estimate the average number of photons per pulse using the same dataset, with experimental data given in blue and a linear fit shown with a black dashed line. The R² value for the linear fit was 0.9976. Based on previous studies, a small percentage (<10%) of photon counts are being missed at the higher photon rates ( 100- 200%) of the experimental data using SPEED, leading to values that are biased slightly lower. This is due to the dead time of the system, 1.0 ns, or twice the sampling rate. The intensity of higher photon rates can be more accurately characterized by non-photon-counting methods such as direct pulse sampling which does not have a dead time, however it produces biased intensity values at low photon rates and inaccurate fluorescence lifetime values. The SPEED method requires high sampling rate (>1 GS/s) to maintain the integrity of the original signal, and therefore has high consumption on acquisition and computation; whereas the photon counting method using binomial fitting can simply uses the integrated/averaged signal collected at lower digitization rates. However, the SPEED method provides precise temporal information for photon counts, which can be used to recreate fluorescence decay curves and estimate fluorescence lifetime.

### High-Sensitivity Quantitative Measurement Beyond the Limitation of Continuous Photon Statistic

This binomial fitting method based on homogeneous solution can be used not only for the conversion of photoelectron counts, but also for the identification of the detection limit of the analog PMT. By taking the logarithm of Eqn. (5), it can be converted to:

$${log}_{10} ( Mean / Std . ) = {log}_{10} \sqrt{\frac{m}{1 - p}} + \frac{1}{2} {log}_{10} N p \qquad ( 6 )$$

where the first term on the right side of the Eqn. (6) is a constant. If

$${log}_{10} \sqrt{\frac{m}{1 - p}}$$

is replaced by c, log₁₀ (Mean/Std.) is replaced by y, and log₁₀(Np) is replaced by x, Eqn. (6) can be simplified to:

$$y = \frac{1}{2} x + c \qquad ( 7 )$$

Since Np and Mean/Std. are the horizontal and vertical coordinates of the binomial fitting graph (as shown in FIG. 20), this means that a linear theoretical curve with a slope of ½ can be obtained by taking the logarithm for the binomial fitting graph. Furthermore, the logarithmic operation makes the data fitting of low photon rate more visual, which enables the identification of the PMT detection limit. Mathematically, the signal of detection limit (S_{dl}) is equal to the addition of the mean value of the reagent blank measured multiple times (S_{reag}) and 3 times the standard deviation (σ_{reag}): S_{dl}=S_{reag}+3σ_{reag}.

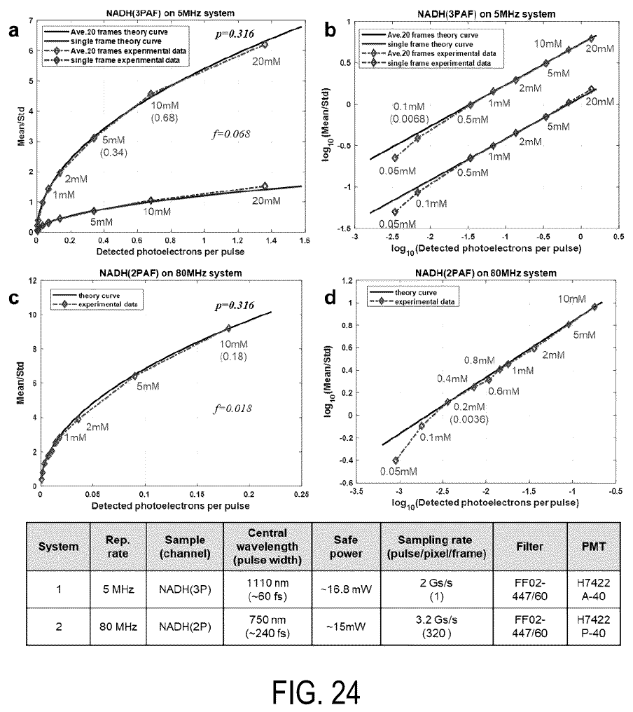

To verify the validity of the binomial fitting method on different systems, and to compare the imaging performance of NADH and FAD on this 5 MHz system and typical 80 MHz systems under photodamage-free conditions, concentration-dependent experiments were performed by using NADH and FAD solutions. FIG. 24 shows NADH concentration-dependent experiments on 5 MHz and 80 MHz system. FIG. 24A and FIG. 24B are binomial fitting and logarithmic operations for NADH concentration-dependent experiments (0.05-20 mM, 16.8 mW on sample) on 3-photon channel of 5 MHz system with single pulse per pixel per frame (signal window size=6 ns), and the magenta and red data points are from an average of 20 frames and a single frame image, respectively. FIG. 24C and FIG. 24D are binomial fitting and logarithmic operations for NADH concentration-dependent experiments (0.05-10 mM, 15 mW on sample) on 2-photon channel of 80 MHz system with 320 pulses per pixel per frame (signal window size=3.125 ns), and the magenta data points are from a single frame image. NADH concentration-dependent experiments on 5 MHz and 80 MHz system were specified in the table, and the gain voltage of all PMTs was set to 0.8 V. To match the range of digitizer input voltage (±400 mV fixed input range for ATS9373), a 20 dB attenuator is connected after the amplifier. Note that PMT H7422A-40 has protection circuit and will trip if the output current exceeds 50 μA; PMT H7422P-40 is selected for lower than average dark current and higher than average gain, which is important for photon counting. The results indicated that the binomial fitting method was applicable to the 5 MHz system and 80 MHz system with different detection and acquisition schemes. A suitable signal window larger than the fluorescence lifetime of the target sample should be used to facilitate the binomial fit and identification of the PMT detection limit.

For laser scanning fluorescence imaging, the signal occupies only a small part between laser pulses, and the rest is useless noise, especially for the low repetition rate laser imaging system. To reduce the adverse effects of such noise, time-gated window was used for denoising and data saving. For this system, the frame rate is mainly affected by the data transfer and real-time storage of 2-photon and 3-photon channels with 2 GS/s dual-channel high-speed sampling, because the storage of raw data with as little loss of frame rate as possible is a huge challenge due to the limited data transfer and storage rates. However, for a laser scanning fluorescence imaging system with low repetition rate, the signal only occupies a small part of the data sampling points between the laser pulses, and the rest are useless noise data points. For the 2-photon and 3-photon channels of this system (5 MHz repetition rate and 2 GS/s sampling rate), there are 400 sampling points between pulses, but the fluorescence lifetime of FAD and NAD(P)H is less than 10 ns (20 sampling points), so at least 95% of the data points are noise signals. To solve this problem, the position of the maximum value within each line of fast scan was first found by superimposing the raw data of all the pixel with the line, and then the custom data points near the maximum value position (time-gated window) are extracted and saved, which can be easily set through the custom LabVIEW-based GUI. This system is generally set to extract 40 data points per pulse for saving, 9 before the maximum value and 30 after the maximum value. Therefore, compared to saving all the raw data, 90% useless data is reduced by implementing this algorithm in the GPU.

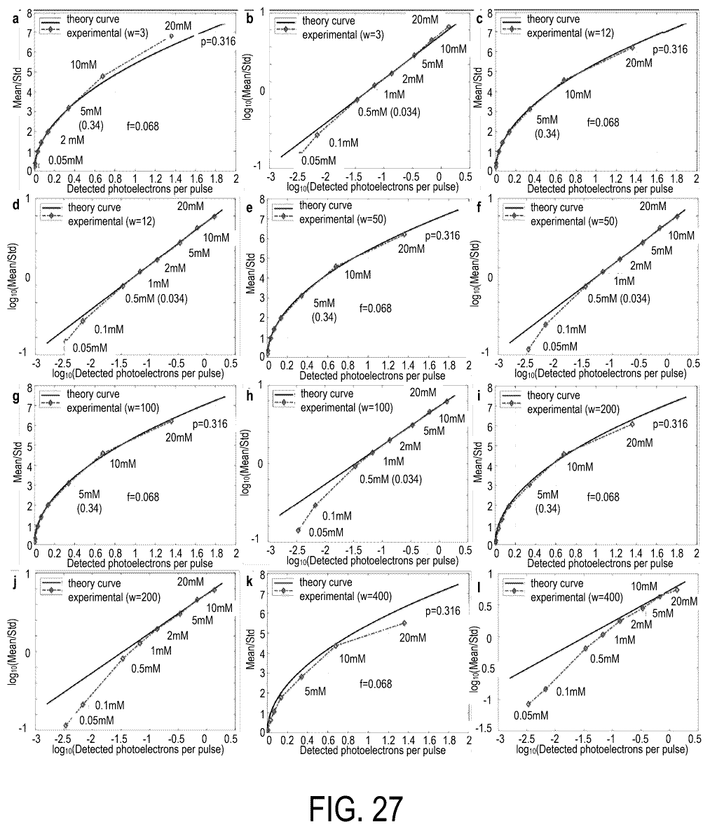

To verify the effect of signal window size on photon counting using binomial fitting and quantification of PMT detection limit, raw data of 3-photon excitation signals of NADH concentration-dependent experiments were collected using a 2 Gs/s digitizer (ATS9373, AlazarTech) on the low repetition rate 5 MHz system. The results (FIG. 27) showed that when the signal window size exceeded a certain threshold (window=100 (50 ns) for this case (FIG. 27G, FIG. 27H), both the binomial fitting and the quantification of the detection limit become worse (>0.34 photoelectrons/pulse); when the window size was too small, they were also affected, especially in the high concentration condition (10/20 mM). The optimal window size should be slightly longer than the fluorescence lifetime of the target sample to be detected (FIG. 27C-27F). This conclusion was also confirmed on the high repetition rate 80 MHz system with 3.2 Gs/s sampling rate, but the duty cycle of the signal between pulses was larger than that of the 5 MHz system, its influence on the fitting was relatively small. FIG. 27 shows the effect of signal window size on binomial fitting and PMT detection limit on 5 MHz system with 16.8 mW on sample. This analysis was conducted based on NADH concentration-dependent experiments (0.05-20 mM). The pulse interval is 200 ns, which contains 400 sampling windows. Graphs a/c/e/g/i/k are photon counting using binomial fitting method, and graphs b/d/f/h/j/l are corresponding logarithmic operations of binomial fitting results. The (a) and (b) window=3, (c) and (d) window=12, (e) and (f) window=50, (g) and (h) window=100, (i) and (j) window=200, and (k) and (1) window=400.

Meanwhile, the experiment also proved that the detection limit of PMT becomes more sensitive with the increase of gain voltage. To verify the effect of the gain setting of the PMT on the detection limit, two sets of NADH concentration-dependent experiments with different gain settings (Gain voltage: 0.6 V and 0.8 V) were performed on the same system (5 MHz) with the same detection channel (3-photon) and PMT (H7422A-40). The results showed that the detection limit of PMT becomes more sensitive with the increase of gain voltage (˜0.044 photoelectrons/pulse for 0.6 V gain voltage, ˜0.0136 photoelectrons/pulse for 0.8 V gain voltage), but the increase of detection limit (˜3.2 times) is not proportional to the increase of gain (˜7 times, 0.6 V:˜7×104, 0.8 V:˜5×105).

From FIGS. 24A and 24B, it can be seen that this method is suitable for single-frame imaging with single pulse each pixel and multi-frame average imaging, and the number of photoelectrons converted at the same condition is the same (i.e., the average number of photoelectron detected per pulse at 5 mM is 0.34), which is consistent with the theory of Eqn. (6), and the fit of multi-frame average imaging is similar to single frame imaging. Meanwhile, the detection limit fell between 0.1 mM (mean 0.0068 photoelectron/pulse) and 0.5 mM (mean 0.034 photoelectron/pulse) according to mathematical theory, which is consistent with the minimum fitting concentration in FIG. 24B. Furthermore, this method is also applicable to imaging with multi-pulse each pixel (i.e., FIGS. 24C and 24D).

For NADH, by comparing FIGS. 24A-24D, it can be known that the 3-photon signal excited by 1110 nm wavelength with a repetition rate of 5 MHZ (mean 0.68 photoelectron/pulse for 10 mM) exceeded the 2-photon signal excited by 750 nm wavelength with a repetition rate of 80 MHz (mean 0.18 photoelectron/pulse for 10 mM) under the corresponding safe power. However, due to the low repetition rate, the 5 MHz system produces fewer photoelectrons (mean 3.4 photoelectrons/μs for 10 mM) than the 80 MHz system (mean 14.4 photoelectron/μs for 10 mM) in the same time period. Meanwhile, the detection limits of the above two detection schemes were similar, around 0.2 mM, corresponding to an average of ˜0.0136 and ˜0.0036 photoelectron per pulse, respectively.

The measurement of each photoelectron is affected by the statistical uncertainty of the readout noise σ_{R}, and only when σ_{R} is less than 0.5 photoelectrons (rms), the photon detector has the ability to resolve individual incident photons (photon-resolving capability). However, according to the above analysis, the quantifiable detection limit of PMT was found to be much smaller than 0.5 photoelectrons, but its photoelectron statistical histogram is continuous (insets of FIG. 20), and there is no boundary between photoelectrons in the histogram, which seems to be inconsistent with the theory. The reason is that the continuous photon statistical histogram of PMT is caused by its internal amplification noise (>0.5 photoelectrons), not the readout noise (<<0.5 photoelectrons). This is the physical basis that the binomial fitting method proposed in this paper is possible to distinguish between various photoelectrons beyond the limitation of continuous photon statistical characteristics. Moreover, this method provides a new photon number resolving in addition to temporal photon number resolving and can identify a very low photon detection limit (about 2 orders of magnitude smaller than 0.5 photoelectrons) with high sensitivity even if the amplification noise is greater than 0.5 photoelectrons.

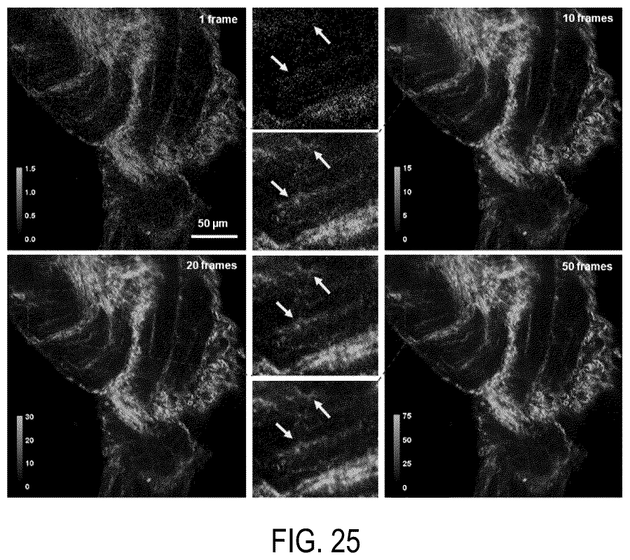

To demonstrate the photon resolving capability using this binominal fitting method, the SHG image of a mouse embryo (Day 8) were used for photon number conversion superimposed with different frame numbers (FIG. 25). The power on sample was 14.4 mW, at 1 pulse/pixel/frame and a repetition rate of 5 MHz. At the same time, the THG imaging of astrocytes in the mouse skull (FIG. 17) were used to demonstrate the impact of photon resolving on quantitative imaging by setting the value of pixels with more than 1 photon per pulse in the image to 1-6.

### Quantification

Compared with photon counting PMT, analog PMT has more efficient photon detection capability at high photon rate. However, the output of analog PMT (current/voltage) is related to the settings of the gain voltage, the quantum efficiency (QE) of the target wavelength, the connected amplifier or attenuator, etc. Therefore, even if the same analog PMT with different settings is used to detect the same photon input, its output will be different, let alone the quantitative comparison between different types of analog PMTs. By using the converted photon counts as the quantification criterion, one can not only realize the conversion to photon counts for the same analog PMT under different gain settings, but also enable the comparison across different types of PMTs from different setups. Furthermore, for multi-channel multi-modal spectral imaging, by establishing the photon crosstalk matrix of the target sample in different channels, the signal crosstalk error between different channels can be compensated for using the crosstalk inverse matrix.

To demonstrate the quantification capability of the 5 MHz system using the photon counting method, a piece of ex vivo unlabeled rabbit kidney tissue was observed with 15.6 mW average power on sample, as shown in FIG. 16, described in more detail above. It can be seen from the crosstalk matrix that the leakage of the 2-photon signal to the SHG channel is the main leakage of this 5 MHz system. After signal compensation, these leaked photons were compensated back to the 2-photon image, so the clean fiber (SHG) signal can be observed. Meanwhile, this 5 MHz system also has the ability to quantify the fluorescence lifetime of 2-photon and 3-photon signals. By comparing 2PAF and 3PAF in FIG. 16, different fluorescence lifetimes can be clearly distinguished between 2-photon and 3-photon signals, and the phasor plots of the fluorescence lifetimes were also drawn in 2PAF and 3PAF, which were consistent to the distribution of FAD and NAD(P)H. Interestingly, two substances with different fluorescence lifetimes were observed in the 2-photon channel. Importantly, phototoxicity was not observed in the fluorescent channels during 50-frames imaging period (˜90 s), only photobleaching occurred as a gradual decrease in image intensity.

### Quantification on Cells

To demonstrate the quantitative imaging capability of the 5 MHz system on label-free cells employing this photon counting method, in vitro imaging experiments of hamster kidney cells (BHK-21) were performed to observe the dynamics of the 3-photon fluorescence intensity of NADH during apoptosis, which was achieved by addition of 100 μL of 20 μM staurosporine (STS) into the 2 mL of cell culture media, for a final concentration of 1 μM STS in the imaging dishes (35 mm petri dish, MatTek). STS was added using a micropipette around 50 frames (90 seconds, black arrow in FIG. 5c) after the start of dynamic image acquisition. The experimental results showed that the NADH 3-photon fluorescence signal intensity/converted photons and average lifetime of hamster kidney cells increases after adding STS, which is consistent with the theory (reference). The superimposed photon number per pixel of the segmented cells increased from 1.019 photons/pixel for 1-50 frames to 1.245 photons/pixel for 51-100 frames, and the photon statistics histogram of 50 frames before and after adding STS also clearly shows this change. The average fluorescence lifetime of the 3-photon channel signal (NADH) of the segmented hamster kidney cells increased from about 1.2 ns to about 1.5 ns before and after adding STS. At the same time, the system can capture the rapid response process of cells after adding STS.

### Compatible With Hybrid Photodetector (HPD) and Electron Multiplying CCD (EM-CCD) Camera

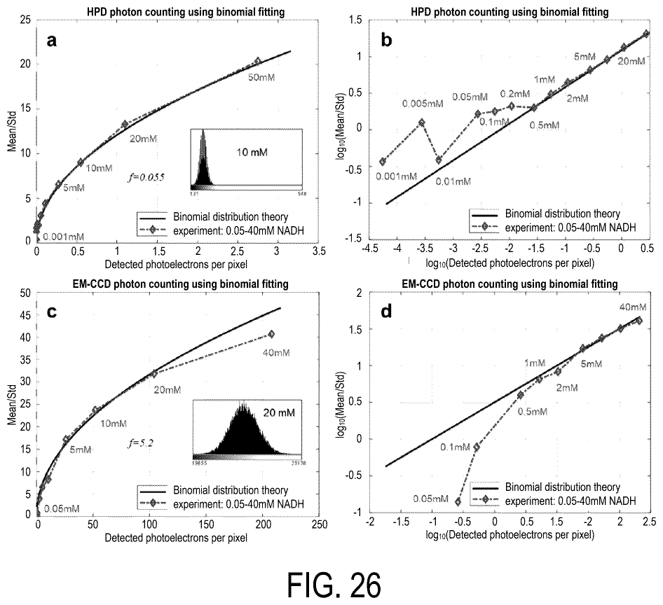

FIG. 26 shows compatibility verification of the photon counting method using binomial fitting on HPD and EMCCD camera based on NADH concentration-dependent experiments. FIG. 26A shows binomial fitting (ƒ=0.055) on HPD based on single frame imaging from 0.001 to 50 mM NADH with parameters of excitation wavelength: 750 nm, power on sample: 30 mW, control voltage: V, pixel dwell time: 2.5 μs (200 pulse/pixel), sampling rate: 5 Gs/s, time-gated window: 50 (10 ns); ˜2.7 photoelectrons per pulse can be generated for 50 mM NADH at above imaging condition. FIG. 26B shows the logarithm of FIG. 26A, the detection limit of HPD is ˜0.026 photoelectrons per pulse on average, corresponding to 0.5 mM NADH. FIG. 26C shows binomial fitting (f=5.2) on EM-CCD based on single frame imaging from 0.05 to 40 mM NADH; excitation wavelength: 405 nm (continuous-wave laser), EM gain: 40, power: 13.1 dBm, exposure time: 50 ms, emission filter: FF02-447/60 (semrock), Objective: Plan-Apochromat 63×/1.4;˜104 photoelectrons per pulse can be generated for 20 mM NADH at above imaging condition. FIG. 26D shows the logarithm of FIG. 26C, the detection limit of EM-CCD is ˜2.6 photoelectrons per pulse on average, corresponding to 0.5 mM NADH.

For HPD and EM-CCD, the conversion and collection of photons also follows the Poisson distribution. To verify the applicability of this method on these two types of detectors, concentration-dependent solution experiments were first performed by using a HPD (R10467U-40, Hamamatsu) to acquire the 2-photon signal of the NADH solution on an 80 MHz multiphoton imaging platform, as shown in FIG. 26A and 26B. Similarly, this method was also validated on a wide-field microscope by collecting fluorescence signals of different-concentration NADH solution using a cooled EM-CCD camera (512 Evolve, Photometrics) with high sensitivity for low-light fluorescence imaging, as shown in FIG. 20B. The above experimental results show that the method of photon counting using binomial fitting is not only applicable to analog PMT, but also to HPD and EM-CCD. The detection limit of HPD is about 0.026 photoelectrons per pulse on average, whereas the detection limit of EM-CCD is about 2.6 photoelectrons per pulse on average and the maximum detectable boundary is about 104 photoelectrons per pulse on average.

### Effect of ROI Selection on Fitting of Experimental Data

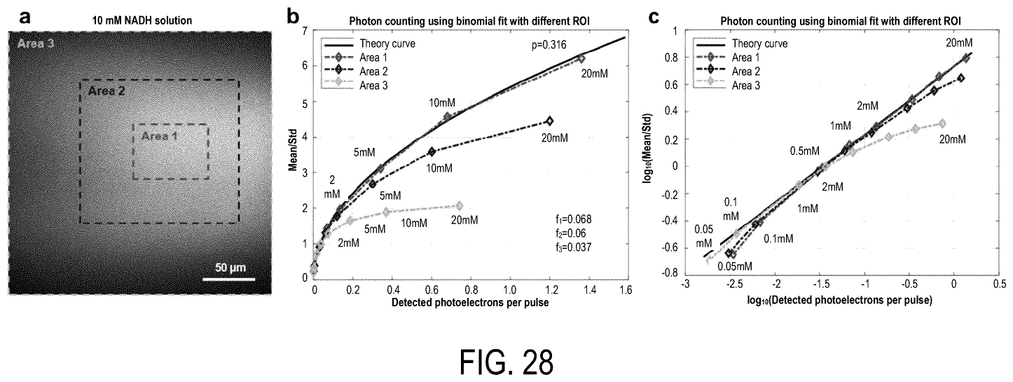

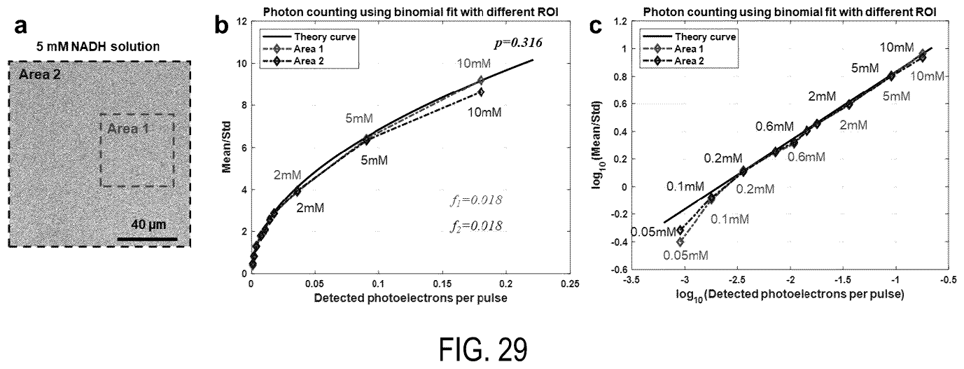

To verify the effect of the ROI selection on the binomial fitting of experimental data, different ROIs from the imaging of both 5 MHz (FIGS. 28) and 80 MHz (FIG. 29) system were selected for binomial fit based on NADH concentration-dependent imaging. FIG. 28 shows the effect of ROI selection on the binomial fitting of experimental data from 5 MHz system with 250 μm×250 μm FOV, window size=12. FIG. 28A shows 3-photon imaging of 10 mM NADH solution with three different ROI selection. FIG. 28B shows binomial fits for the three different areas in a based on 3-photon imaging (avg. 20 frames) of NADH concentration-dependent experiments (0.05-20 mM). FIG. 28C illustrates a logarithmic operation of the data in FIG. 28B to show the effect of ROI selection on the fit of low concentration data. FIG. 29 shows the effect of ROI selection on the binomial fitting of experimental data from 80 MHz system with 120 μm×120 μm FOV, window size=10. FIG. 29A shows 2-photon imaging of 5 mM NADH solution with two different ROI selection. FIG. 29B shows binomial fits for the three different areas in a based on 2-photon imaging (single frame) of NADH concentration-dependent experiments (0.05-20 mM). FIG. 29C is a logarithmic operation of the data in FIG. 29B to show the effect of ROI selection on the fit of low concentration data.

For the 5 MHz system, the imaging FOV was set to 250 μm×250 μm using 40× objective (UAPON 40XW340, Olympus), and three ROIs (FIG. 28A) were selected. The results (FIG. 28) show that as the ROI area increases, the fitting results become worse, and the number of photons generated per pulse at the same concentration gradually decreases, which is caused by the uneven focus in the imaging FOV, resulting in the number of excited photons less than uniform focus area (Area 1 of FIG. 28A) in partial area. This will not affect the accuracy of the correspondence between photon counts and pixel gray values, it will only make data fitting difficult.

However, for the 80 MHz system with 120 μm×120 μm FOV using 25× objective (XL Plan N 25X, Olympus), changing the ROI has no effect on the binomial fitting results due to the uniform focus across the entire FOV (FIG. 29). The deviation of the 10 mM data point (FIG. 29B) is due to the inhomogeneous distribution caused by the change of the solution under laser irradiation. Therefore, for the large FOV imaging, to facilitate photon counting, a uniform focal region should be chosen to perform the fitting.

### Flowchart

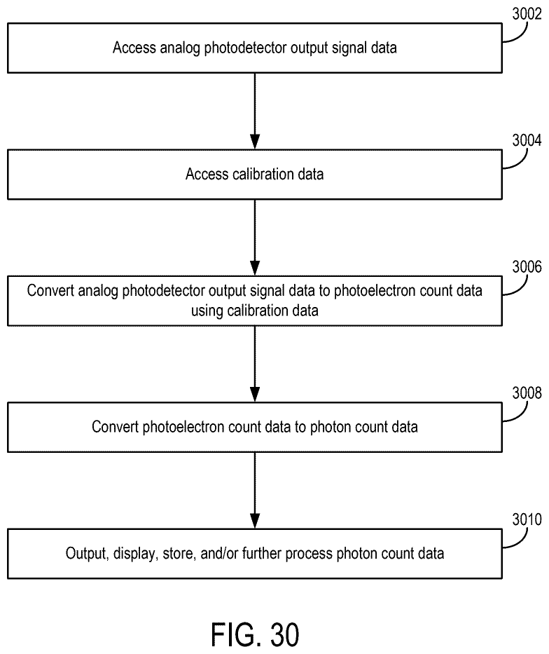

Referring now to FIG. 30, a flowchart is illustrated as setting forth the steps of an example method for converting analog photodetector output signal data to quantitative photon count data using the PCEP techniques described in the present disclosure.

The method includes receiving, or otherwise accessing, analog photodetector output signal data with a computer system or processor, as indicated at step 3002. Accessing the analog photodetector output signal data may include retrieving such data from a memory or other suitable data storage device or medium. Additionally or alternatively, accessing the analog photodetector output signal data may include acquiring such data with an imaging and/or microscopy system (e.g., an eSLAM system, a pSLAM system, a SLAM system, an MPM system, etc.) and transferring or otherwise communicating the data to the computer system, which may be a part of the imaging and/or microscopy system.

Calibration data are also accessed by the computer system or processor, as indicated at step 3004. In general, the calibration data relate image pixel gray values in the analog photodetector output signal data to a number of detected photoelectrons for the imaging system used to collect the analog photodetector output signal data (e.g., the analog photodetector(s) of that system). Accessing the calibration data may include retrieving such data from a memory or other suitable data storage device or medium. Additionally or alternatively, accessing the calibration data may include generating such data, as described above in more detail, such as by determining correlations between image pixel gray values and photoelectron counts.

Photoelectron count data are generated from the analog photodetector output signal data using the computer system or processor, as indicated at step 3006. The analog photodetector output signal data can be converted to photoelectron counts using the calibration data, as described above in more detail.

Quantitative photon count data are then generated by converting the photoelectron count data to photon count data, as indicated at step 3008. For example, the photoelectron count data can be converted to photon count data based in part on a probability of converting a photon to a photoelectron, as described above in more detail.

The quantitative photon count data can then be output to a user, stored for later use or further processing, or both, as indicated at step 3010. For example, as described above, additional processing may include quantifying and correcting channel crosstalk for multichannel and/or multispectral imaging systems. Additionally or alternatively, further processing of the quantitative photon count data may include generating absolute measurements from the data. For instance, local concentration measurements and/or images may be generated, fluorescence lifetime measurements and/or images may be generated, ratio-metric measurements (e.g., optical metabolism, FRET, etc.) may be generated, and so on. Additionally or alternatively, photo-bleaching of fluorophores may be monitored based in part on the quantitative photon count data. As another example, the quantitative photon count data can be used to improve the reproducible aspect of molecular imaging by correcting uneven field illumination, simplifying imaging metadata, taking photo-toxicity into consideration, and optimizing the platform of molecular imaging. As yet another example, the quantitative photon count data can be used to the quality control aspect of molecular imaging by testing simple phantoms, enabling device/modality inter-comparison, monitoring hardware failure and aging, and standardizing image format and storage.

### Computer Systems

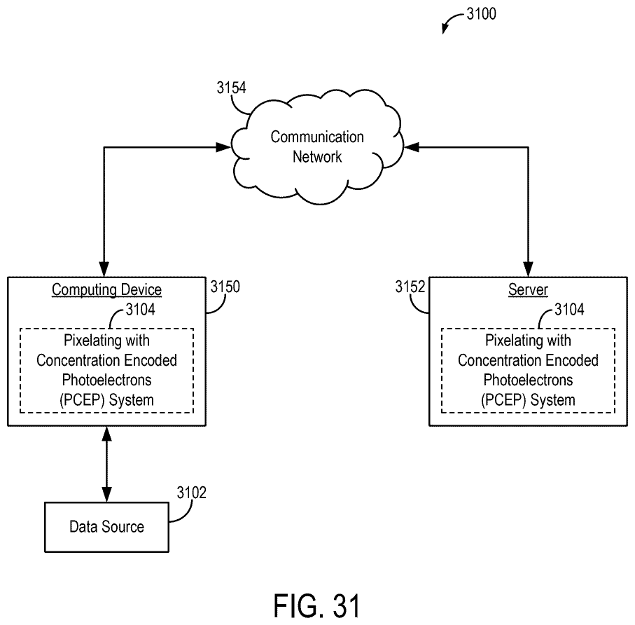

FIG. 31 shows an example system 3100 for generating quantitative photon count data from analog photodetector output signal data in accordance with some embodiments of the systems and methods described in the present disclosure. As shown in FIG. 31, a computing device 3150 can receive one or more types of data (e.g., analog photodetector output signal data, calibration data, photoelectron count data, etc.) from data source 3102. In some embodiments, computing device 3150 can execute at least a portion of a pixelating with concentration encoded photoelectrons (PCEP) system 3104 to convert analog photodetector output signal data received from the data source 3102 to quantitative photon count data.

Additionally or alternatively, in some embodiments, the computing device 3150 can communicate information about data received from the data source 3102 to a server 3152 over a communication network 3154, which can execute at least a portion of the PCEP system 3104. In such embodiments, the server 3152 can return information to the computing device 3150 (and/or any other suitable computing device) indicative of an output of the PCEP system 3104.

In some embodiments, computing device 3150 and/or server 3152 can be any suitable computing device or combination of devices, such as a desktop computer, a laptop computer, a smartphone, a tablet computer, a wearable computer, a server computer, a virtual machine being executed by a physical computing device, and so on. The computing device 3150 and/or server 3152 can also reconstruct images from the data.

In some embodiments, data source 3102 can be any suitable source of data (e.g., analog photodetector output signal data, calibration data), such as a microscopy system, another computing device (e.g., a server storing analog photodetector output signal data, calibration data), and so on. In some embodiments, data source 3102 can be local to computing device 3150. For example, data source 3102 can be incorporated with computing device 3150 (e.g., computing device 3150 can be configured as part of a device for measuring, recording, estimating, acquiring, or otherwise collecting or storing data). As another example, data source 3102 can be connected to computing device 3150 by a cable, a direct wireless link, and so on. Additionally or alternatively, in some embodiments, data source 3102 can be located locally and/or remotely from computing device 3150, and can communicate data to computing device 3150 (and/or server 3152) via a communication network (e.g., communication network 3154).

In some embodiments, communication network 3154 can be any suitable communication network or combination of communication networks. For example, communication network 3154 can include a Wi-Fi network (which can include one or more wireless routers, one or more switches, etc.), a peer-to-peer network (e.g., a Bluetooth network), a cellular network (e.g., a 3G network, a 4G network, etc., complying with any suitable standard, such as CDMA, GSM, LTE, LTE Advanced, WiMAX, etc.), other types of wireless network, a wired network, and so on. In some embodiments, communication network 3154 can be a local area network, a wide area network, a public network (e.g., the Internet), a private or semi-private network (e.g., a corporate or university intranet), any other suitable type of network, or any suitable combination of networks. Communications links shown in FIG. 31 can each be any suitable communications link or combination of communications links, such as wired links, fiber optic links, Wi-Fi links, Bluetooth links, cellular links, and so on.

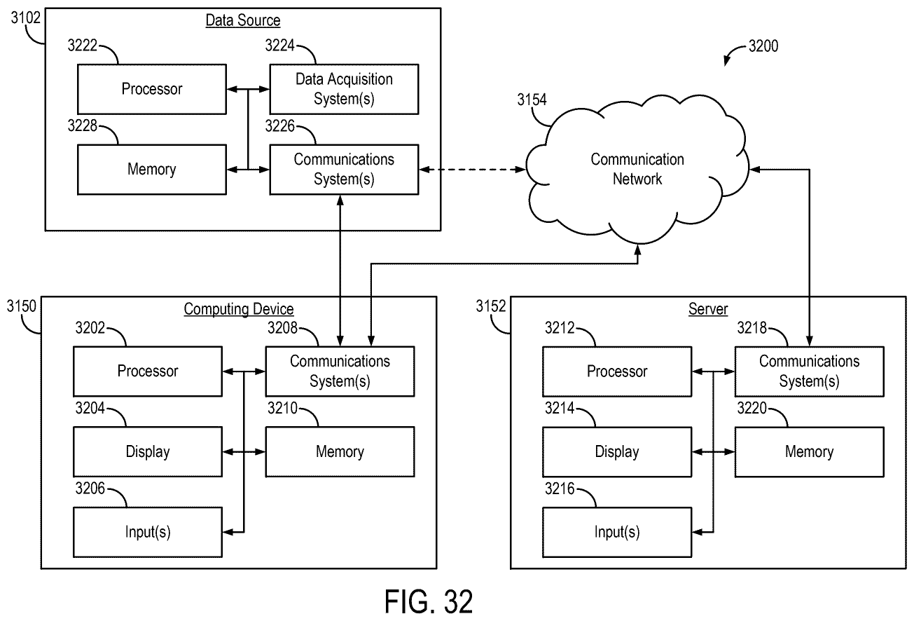

Referring now to FIG. 32, an example of hardware 3200 that can be used to implement data source 3102, computing device 3150, and server 3152 in accordance with some embodiments of the systems and methods described in the present disclosure is shown.

As shown in FIG. 32, in some embodiments, computing device 3150 can include a processor 3202, a display 3204, one or more inputs 3206, one or more communication systems 3208, and/or memory 3210. In some embodiments, processor 3202 can be any suitable hardware processor or combination of processors, such as a central processing unit (“CPU”), a graphics processing unit (“GPU”), and so on. In some embodiments, display 3204 can include any suitable display devices, such as a liquid crystal display (“LCD”) screen, a light-emitting diode (“LED”) display, an organic LED (“OLED”) display, an electrophoretic display (e.g., an “e-ink” display), a computer monitor, a touchscreen, a television, and so on. In some embodiments, inputs 3206 can include any suitable input devices and/or sensors that can be used to receive user input, such as a keyboard, a mouse, a touchscreen, a microphone, and so on.

In some embodiments, communications systems 3208 can include any suitable hardware, firmware, and/or software for communicating information over communication network 3154 and/or any other suitable communication networks. For example, communications systems 3208 can include one or more transceivers, one or more communication chips and/or chip sets, and so on. In a more particular example, communications systems 3208 can include hardware, firmware, and/or software that can be used to establish a Wi-Fi connection, a Bluetooth connection, a cellular connection, an Ethernet connection, and so on.

In some embodiments, memory 3210 can include any suitable storage device or devices that can be used to store instructions, values, data, or the like, that can be used, for example, by processor 3202 to present content using display 3204, to communicate with server 3152 via communications system(s) 3208, and so on. Memory 3210 can include any suitable volatile memory, non-volatile memory, storage, or any suitable combination thereof. For example, memory 3210 can include random-access memory (“RAM”), read-only memory (“ROM”), electrically programmable ROM (“EPROM”), electrically erasable ROM (“EEPROM”), other forms of volatile memory, other forms of non-volatile memory, one or more forms of semi-volatile memory, one or more flash drives, one or more hard disks, one or more solid state drives, one or more optical drives, and so on. In some embodiments, memory 3210 can have encoded thereon, or otherwise stored therein, a computer program for controlling operation of computing device 3150. In such embodiments, processor 3202 can execute at least a portion of the computer program to present content (e.g., images, user interfaces, graphics, tables), receive content from server 3152, transmit information to server 3152, and so on. For example, the processor 3202 and the memory 3210 can be configured to perform the methods described herein.

In some embodiments, server 3152 can include a processor 3212, a display 3214, one or more inputs 3216, one or more communications systems 3218, and/or memory 3220. In some embodiments, processor 3212 can be any suitable hardware processor or combination of processors, such as a CPU, a GPU, and so on. In some embodiments, display 3214 can include any suitable display devices, such as an LCD screen, LED display, OLED display, electrophoretic display, a computer monitor, a touchscreen, a television, and so on. In some embodiments, inputs 3216 can include any suitable input devices and/or sensors that can be used to receive user input, such as a keyboard, a mouse, a touchscreen, a microphone, and so on.

In some embodiments, communications systems 3218 can include any suitable hardware, firmware, and/or software for communicating information over communication network 3154 and/or any other suitable communication networks. For example, communications systems 3218 can include one or more transceivers, one or more communication chips and/or chip sets, and so on. In a more particular example, communications systems 3218 can include hardware, firmware, and/or software that can be used to establish a Wi-Fi connection, a Bluetooth connection, a cellular connection, an Ethernet connection, and so on.

In some embodiments, memory 3220 can include any suitable storage device or devices that can be used to store instructions, values, data, or the like, that can be used, for example, by processor 3212 to present content using display 3214, to communicate with one or more computing devices 3150, and so on. Memory 3220 can include any suitable volatile memory, non-volatile memory, storage, or any suitable combination thereof. For example, memory 3220 can include RAM, ROM, EPROM, EEPROM, other types of volatile memory, other types of non-volatile memory, one or more types of semi-volatile memory, one or more flash drives, one or more hard disks, one or more solid state drives, one or more optical drives, and so on. In some embodiments, memory 3220 can have encoded thereon a server program for controlling operation of server 3152. In such embodiments, processor 3212 can execute at least a portion of the server program to transmit information and/or content (e.g., data, images, a user interface) to one or more computing devices 3150, receive information and/or content from one or more computing devices 3150, receive instructions from one or more devices (e.g., a personal computer, a laptop computer, a tablet computer, a smartphone), and so on.

In some embodiments, the server 3152 is configured to perform the methods described in the present disclosure. For example, the processor 3212 and memory 3220 can be configured to perform the methods described herein.

In some embodiments, data source 3102 can include a processor 3222, one or more data acquisition systems 3224, one or more communications systems 3226, and/or memory 3228. In some embodiments, processor 3222 can be any suitable hardware processor or combination of processors, such as a CPU, a GPU, and so on. In some embodiments, the one or more data acquisition systems 3224 are generally configured to acquire data, images, or both, and can include an eSLAM system, a pSLAM system, a SLAM system, an MPM system, or other suitable imaging and/or microscopy system using analog photodetectors. Additionally or alternatively, in some embodiments, the one or more data acquisition systems 3224 can include any suitable hardware, firmware, and/or software for coupling to and/or controlling operations of an eSLAM system, a pSLAM system, a SLAM system, an MPM system, or other suitable imaging and/or microscopy system using analog photodetectors. In some embodiments, one or more portions of the data acquisition system(s) 3224 can be removable and/or replaceable.

Note that, although not shown, data source 3102 can include any suitable inputs and/or outputs. For example, data source 3102 can include input devices and/or sensors that can be used to receive user input, such as a keyboard, a mouse, a touchscreen, a microphone, a trackpad, a trackball, and so on. As another example, data source 3102 can include any suitable display devices, such as an LCD screen, an LED display, an OLED display, an electrophoretic display, a computer monitor, a touchscreen, a television, etc., one or more speakers, and so on.

In some embodiments, communications systems 3226 can include any suitable hardware, firmware, and/or software for communicating information to computing device 3150 (and, in some embodiments, over communication network 3154 and/or any other suitable communication networks). For example, communications systems 3226 can include one or more transceivers, one or more communication chips and/or chip sets, and so on. In a more particular example, communications systems 3226 can include hardware, firmware, and/or software that can be used to establish a wired connection using any suitable port and/or communication standard (e.g., VGA, DVI video, USB, RS-232, etc.), Wi-Fi connection, a Bluetooth connection, a cellular connection, an Ethernet connection, and so on.

In some embodiments, memory 3228 can include any suitable storage device or devices that can be used to store instructions, values, data, or the like, that can be used, for example, by processor 3222 to control the one or more data acquisition systems 3224, and/or receive data from the one or more data acquisition systems 3224; to generate images from data; present content (e.g., data, images, a user interface) using a display; communicate with one or more computing devices 3150; and so on. Memory 3228 can include any suitable volatile memory, non-volatile memory, storage, or any suitable combination thereof. For example, memory 3228 can include RAM, ROM, EPROM, EEPROM, other types of volatile memory, other types of non-volatile memory, one or more types of semi-volatile memory, one or more flash drives, one or more hard disks, one or more solid state drives, one or more optical drives, and so on. In some embodiments, memory 3228 can have encoded thereon, or otherwise stored therein, a program for controlling operation of data source 3102. In such embodiments, processor 3222 can execute at least a portion of the program to generate images, transmit information and/or content (e.g., data, images, a user interface) to one or more computing devices 3150, receive information and/or content from one or more computing devices 3150, receive instructions from one or more devices (e.g., a personal computer, a laptop computer, a tablet computer, a smartphone, etc.), and so on.

In some embodiments, any suitable computer-readable media can be used for storing instructions for performing the functions and/or processes described herein. For example, in some embodiments, computer-readable media can be transitory or non-transitory. For example, non-transitory computer-readable media can include media such as magnetic media (e.g., hard disks, floppy disks), optical media (e.g., compact discs, digital video discs, Blu-ray discs), semiconductor media (e.g., RAM, flash memory, EPROM, EEPROM), any suitable media that is not fleeting or devoid of any semblance of permanence during transmission, and/or any suitable tangible media. As another example, transitory computer-readable media can include signals on networks, in wires, conductors, optical fibers, circuits, or any suitable media that is fleeting and devoid of any semblance of permanence during transmission, and/or any suitable intangible media.

As used herein in the context of computer implementation, unless otherwise specified or limited, the terms “component,” “system,” “module,” “framework,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

The present disclosure has described one or more preferred embodiments, and it should be appreciated that many equivalents, alternatives, variations, and modifications, aside from those expressly stated, are possible and within the scope of the invention.

1. A method for quantitative molecular imaging using an analog photodetector, the method comprising:
receiving, with a processor, output signal data from the analog photodetector;
converting the output signal data to photon count data using the processor by:
receiving calibration data with the processor, wherein the calibration data relate gray values in the output signal data to a number of detected photoelectrons for the analog photodetector,
converting the output signal data to photoelectron count data using the calibration data, and
converting the photoelectron count data to the photon count data using a probability of converting photons into photoelectrons; and
outputting the photon count data using the processor.

2. The method of claim 1, further comprising quantifying channel crosstalk based in part on the calibration data.

3. The method of claim 2, further comprising generating crosstalk-compensated images using the quantified channel crosstalk.

4. The method of claim 3, wherein generating the crosstalk-compensated images includes generating a transfer function based on the quantified channel crosstalk and applying the transfer function to at least one of the analog photodetector output signal data or the quantified photon count data.

5. The method of claim 1, wherein the calibration data comprise correlations of image pixel gray values in the output signal data to numbers of detected photoelectrons by at least one of a series power-dependent data collected from homogeneous standard solutions or a series of concentration-dependent data collected from homogeneous standard solutions.

6. The method of claim 1, wherein the calibration data are based on a model of Poisson photon statistics.

7. The method of claim 1, wherein the probability of converting photons into electrons is based on a quantum efficiency of the analog photodetector and a collection efficiency of the analog photodetector.

8. The method of claim 1, wherein the analog photodetector is an analog photomultiplier tube.

9. The method of claim 1, further comprising:
scanning an excitation light source on a sample, wherein the sample includes a fluorophore; and
generating the output signal data by the analog photodetector based on an emission response of the fluorophore to the excitation light source.

10. The method of claim 9, further comprising monitoring photo-bleaching or phototoxicity of the sample based on the photon count data, during the scanning of the excitation light source on the sample.

11. A system for quantitative molecular imaging, the system comprising:
an analog photodetector; and
a processor operatively connected to the analog photodetector, the processor being configured to:
receive output signal data from the analog photodetector,
convert the output signal data to photon count data by:
receiving calibration data with the processor, wherein the calibration data relate gray values in the output signal data to a number of detected photoelectrons for the analog photodetector,
converting the output signal data to photoelectron count data using the calibration data, and
converting the photoelectron count data to the photon count data using a probability of converting photons into photoelectrons, and outputting the photon count data using the processor.

12. The system of claim 11, the processor being further configured to quantify channel crosstalk based in part on the calibration data.

13. The system of claim 12, the processor being further configured to generate crosstalk-compensated images using the quantified channel crosstalk.

14. The system of claim 13, the processor being configured to generate the crosstalk-compensated images by generating a transfer function based on the quantified channel crosstalk and applying the transfer function to at least one of the analog photodetector output signal data or the quantified photon count data.

15. The system of claim 11, wherein the calibration data comprise correlations of image pixel gray values in the output signal data to numbers of detected photoelectrons by at least one of a series power-dependent data collected from homogeneous standard solutions or a series of concentration-dependent data collected from homogeneous standard solutions.

16. The system of claim 11, wherein the calibration data are based on a model of Poisson photon statistics.

17. The system of claim 11, wherein the probability of converting photons into electrons is based on a quantum efficiency of the analog photodetector and a collection efficiency of the analog photodetector.

18. The system of claim 11, wherein the analog photodetector is an analog photomultiplier tube.

19. The system of claim 11, further comprising an excitation light source operatively connected to the processor, wherein
the processor is further configured to scan the excitation light source on a sample, wherein the sample includes a fluorophore, and
the analog photodetector is configured to generate the output signal data based on an emission response of the fluorophore to the excitation light source.

20. The system of claim 19, the processor being further configured to monitor photo-bleaching or phototoxicity of the sample based on the photon count data, during the scanning of the excitation light source on the sample.
